(19) United States
(12) Patent Application Publication
(10) Pub. No.: US 2025/0328766 A1
(43) Pub. Date: Oct. 23, 2025

(54) CONTEXT-AWARE MEMORY TIERING FOR MACHINE LEARNING TRAINING

(71) Applicant: Intel Corporation, Santa Clara, CA (US)

(72) Inventors: Sathvik Swaminathan, Bangalore (IN); Sandeep Kumar, Bengaluru (IN); Aravinda Prasad, Bangalore (IN); Sreenivas Subramoney, Bangalore (IN)

(21) Appl. No.: 19/250,630

(22) Filed: Jun. 26, 2025

(51) Int. Cl. G06N 3/082

(52) U.S. Cl. CPC G06N 3/082

(57) ABSTRACT

Techniques for training machine learning models are described. In particular, some examples describe the use of storing out a tensor after a training forward pass if conditions warrant this storage. For example, if the tensor can be stored to a different memory, but still be pre-fetched before it is needed in a backward training pass, then the tensor is stored out in some examples. By storing out tensors, memory is freed for computation of subsequent forward and backward passes. This helps improve page swapping, etc. of data.

### BACKGROUND

Training a machine learning (ML) model is a compute-intensive and memory-intensive operation requiring many hours of compute time and a large amount of memory. The amount of memory required to train large deep neural network (DNN) models is growing at a very fast rate, but adding additional memory capacity is not a feasible solution, both technically (due to scaling challenges) and economically.

To cater to the growing demands for memory and, at the same time, to control growing memory costs, traditional memory tiering solutions are using multiple memory tiers that vary in cost and performance, and place hot or frequently accessed data on faster memory tiers and cold or less frequently accessed data on slower memory tiers.

### BRIEF DESCRIPTION OF DRAWINGS

Various examples in accordance with the present disclosure will be described with reference to the drawings, in which:

FIG. 1 illustrates examples of memory usage for training a machine learning model.

FIG. 2 illustrates examples of systems that support context-aware memory tiering for machine learning training.

FIG. 3 illustrates examples of an eviction data structure.

FIG. 4 illustrates examples of an eviction method.

FIG. 5 illustrates examples of a prefetch method.

FIG. 6 illustrates examples of timing for eviction and prefetching.

FIGS. 7-10 illustrate examples of code that use context-aware memory tiering and examples of hooks for performing this tiering.

FIG. 11 is a flow diagram illustrating operations of a method for training a machine learning model according to some examples.

FIG. 12 illustrates examples training output.

FIG. 13 illustrates examples of a cloud provider network.

FIG. 14 illustrates an example computing system.

FIG. 15 illustrates a block diagram of an example processor and/or System on a Chip (SoC) that may have one or more cores and an integrated memory controller.

FIG. 16 is a block diagram illustrating a computing system configured to implement one or more aspects of the examples described herein.

FIGS. 17A-17C illustrate additional graphics multiprocessors, according to examples.

### DETAILED DESCRIPTION

The present disclosure relates to methods, apparatus, systems, and non-transitory computer-readable storage media for context-aware memory usage.

There are several limitations with traditional memory tiering solutions when applied for DNN training. First, traditional memory tiering solutions are agnostic to DNN workload access patterns, thus, failing to exploit periodic repeated memory access patterns exhibited by DNN training workloads, e.g., accessing the same set of data in a deterministic order in both forward and backward passes.

Second, the traditional memory tiering solutions are reactive, i.e., memory pages being first determined if they are hot or cold. A system implementing the traditional memory tiering solutions moves hot pages to a fast memory tier and cold pages to a slow memory tier based on a memory hotness profile. The hot page detection can take several seconds. Hence, a reactive tiering solution can delay the placement of hot data pages in fast tiers, and in the worst case, by the time hot pages are detected and placed in a fast tier, the DNN training application could have moved on to the next set of hot pages. “Hot pages,” “hot memory pages,” and “hot data pages” are used interchangeably from herein.

Third, traditional memory tiering solutions depend on telemetry or page access profiling information, which are semi-accurate. This is because access profiling is built based on sampling a few page accesses. This often results in hot pages incorrectly classified as cold pages, which, in turn, results in hot pages being placed in slow memory tiers, impacting performance. However, for DNN training workloads with a deterministic access pattern, dependency on telemetry data can be eliminated or minimized.

Traditional memory tiering solutions use different telemetry techniques to classify data into hot and cold pages. Telemetry techniques include tracking accessed bits in Page Table Entry (PTE), hardware counters, etc. Based on the hot/cold classification, data pages are moved to appropriate memory tiers. A traditional DNN-specific approach profiles the memory access pattern by poisoning the PTE bits in the first few epochs of training. An epoch is a forward pass followed by a backward pass of DNN training. The profiled information is used in the subsequent epochs to perform memory tiering. However, such memory tiering solutions do not leverage the periodic nature of DNN workloads, which can eliminate or minimize dependance on telemetry data.

While training some models (e.g., a deep neural network (DNN), etc.), each layer in a forward training pass generates data (e.g., tensors, etc.,) which are saved in memory (e.g., DRAM) and are accessed again in a corresponding layer of a backward pass (e.g., for gradient computation). Note that the backward pass may be called back propagation. Forward propagation is the process of feeding input data through a neural network (having at least one input layer, one or more hidden layers, and the output layer) and obtaining a predicted output. The input data is multiplied by the weights and biases of the network's layers, which produces the outputs of each layer. The outputs are then passed through an activation function, such as ReLU or sigmoid. Backward propagation computes gradients of the model's parameters (weights and biases) with respect to a loss function. These gradients are then used to update the parameters (layer-by-layer) to improve the model's performance. As models add more hidden layers, these hidden layers store more data in memory and increase the training memory footprint which extends training time as it requires more swapping of data, occupying resources including memory and compute longer that could be re-used (especially in a tenant system), etc.

In some model training scenarios, a portion of data (e.g., tensors, vectors, matrices, etc.) exhibits an allocate-use-wait-use behavior such that the data is allocated, then used, and then a long period inactive period before it is used again. Note that a tensor may be of different ranks such as a 0^{th} rank being a scalar (single value), a 1^{st} rank (e.g., a vector or 1-D array), a 2^{nd} rank (e.g., 2-D array or matrix), or nth rank (e.g., n-dimensional array).

Examples detailed herein describe embodiments of context-aware memory tiering optimizations which may be particularly beneficial for deterministic training workloads (e.g., for DNN training). The deterministic memory access patterns of some AI training workloads in different execution contexts (forward/backward pass, layers, epochs, etc.) are exploited for memory tiering (e.g., at a page granularity). Memory tiering is performed proactively without the need (or minimal need) for telemetry data (dynamic memory access profiling). For example, the cold pages that are only accessed in a particular layer of a forward pass are aggressively evicted to slow memory and are proactively prefetched on time to fast memory when they are required again in the corresponding layer of the backward pass.

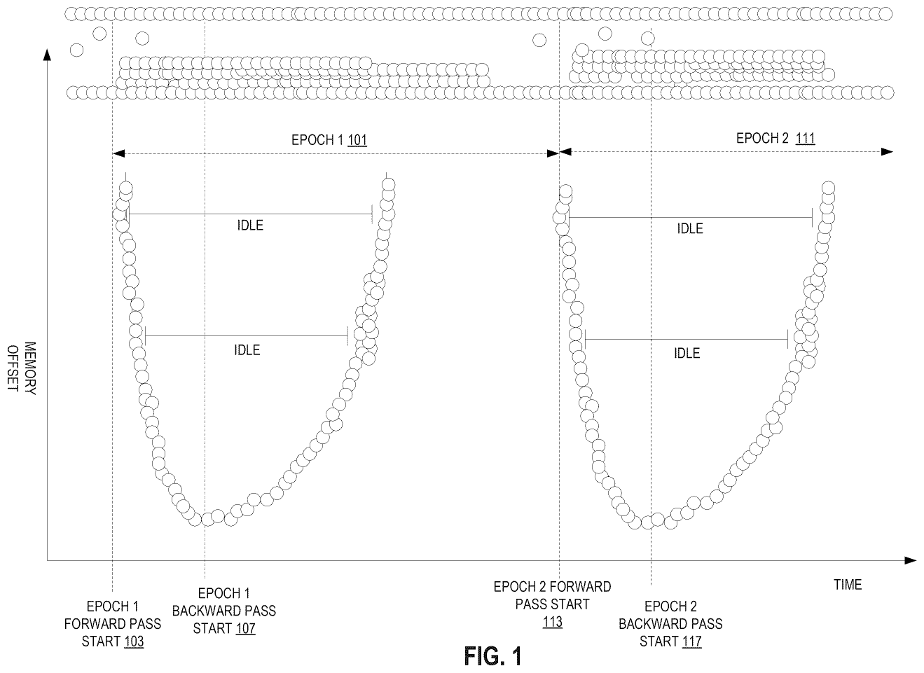

FIG. 1 illustrates examples of memory usage for training a machine learning model, e.g., DNN. In particular, this illustration shows two training epochs. As shown, in each epoch (epoch 1 101 and epoch 2 111) a forward pass starts at forward pass start 103 or 113. During a pass (forward or backward) memory is allocated for data (shown as circles in the figure), but once the data is used the data will be idle until the data is picked up on the backward pass (which starts at 107 or 117). As such, memory is allocated for data for use during the forward pass, then it is used, and then the data is not used until a corresponding backward pass (this follows the allocate-use-wait-use behavior detailed above).

In the described approaches herein, data that is waiting to be used, i.e., inactive data, simply takes up memory that could be used for other tasks. Examples detailed herein move inactive data to a slower storage (e.g., from dynamic random access memory to disk or to a slower memory tier such as non-volatile memory (NVM)). Data from slower memory is then prefetched back to the “fast” memory before it is needed again.

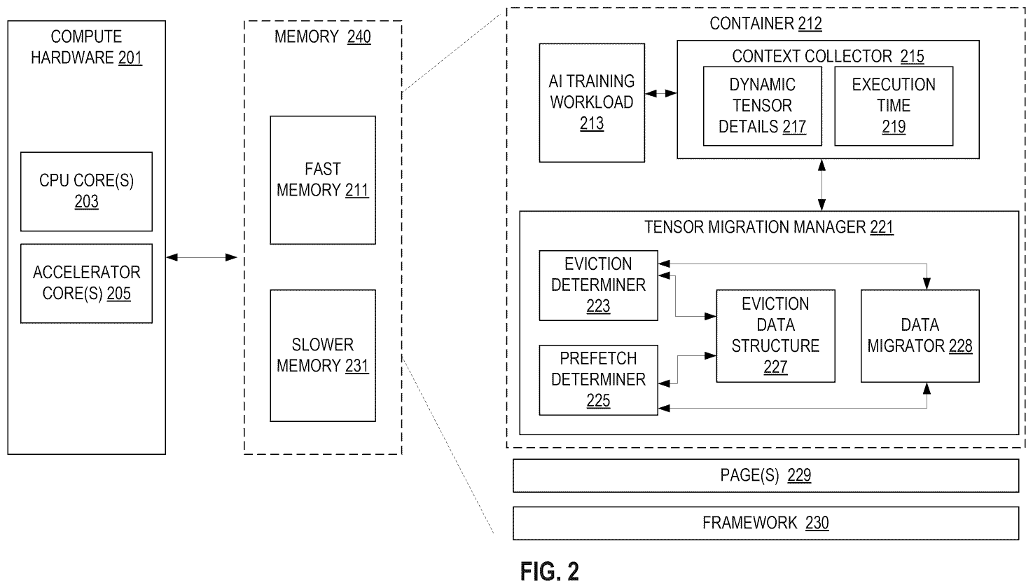

FIG. 2 illustrates examples of systems that support context-aware memory tiering for machine learning training. In some examples, the memory tiering is proactive based on an execution context describing machine learning workload data of a machine learning model that exhibits the allocate-use-wait-use behavior being subjected to memory tiering during the machine learning model training. In some examples, machine learning training comprises training a machine learning algorithm to becomes a machine learning model. In some examples, machine learning training comprises fine-tuning an existing machine learning model.

The systems of FIG. 2 support context-aware memory tiering for machine learning training utilizing a fast memory 211 and a slower memory 231 (which is slower in relation to the fast memory 211) of memory 240.

Examples of fast memory 211 may include, but are not limited to dynamic random-access memory (DRAM), high-bandwidth memory (HBM), etc. Examples of slower memory 231 may include, but are not limited to solid state disks, magnetic disk, phase change memory, NVM, etc. The fast memory 211 is used to store data frequently during training and the slower memory 231 is used to store data that is either not used or is used infrequently for training at a particular point in time. In some examples, the slower memory 231 uses memory pages 229 which are fixed length blocks of virtual memory. In some examples, memory is stored to slower memory 231 as pages and may be loaded back as pages. In some examples, data can be stored and/or loaded at more granular data sizes (e.g., the size of a cache line).

Compute hardware 201 is used to perform machine learning training. In some examples, the compute hardware 201 includes one or more central processing unit (CPU) core(s) 203. In some examples, the CPU core(s) 203 support(s) vector or single instruction, multiple data operations and scalar operations. In some examples, the CPU core(s) 203 support(s) one or more data types such as 1-bit integer (in some examples, having values of −1, 0, or 1), 2-bit integer, 4-bit integer, 8-bit integer, 16-bit integer, 32-bit integer, 64-bit integer, 4-bit floating point (FP4-1 sign bit, 2-bit exponent, 1-bit fraction (1-2-1), or normal float (NF4)), 8-bit floating point (FP8 in either 1-4-3 or 1-5-2 format), 16-bit floating point (e.g., half-precision or brain floating 16 (BF16), 19-bit floating point, 32-bit floating point, 64-bit floating point, etc. In some examples, one or more of the CPU core(s) 203 support(s) includes matrix hardware.

In some examples, the compute hardware 201 includes one or more accelerator core(s) 205 external to the CPU core(s) 203. The accelerator core(s) 205 may include one or more graphics processing unit (GPU) cores, field programmable gate array (FPGA) cores, application specific integrated circuits (ASICs), etc. In some examples, the accelerator core(s) 205 support(s) one or more data types such as 1-bit integer (in some examples, having values of −1, 0, or 1), 2-bit integer, 4-bit integer, 8-bit integer, 16-bit integer, 32-bit integer, 64-bit integer, 4-bit floating point (FP4—1 sign bit, 2-bit exponent, 1-bit fraction (1-2-1), or normal float (NF4)), 8-bit floating point (FP8 in either 1-4-3 or 1-5-2 format), 16-bit floating point (e.g., half-precision or brain floating 16 (BF16), 19-bit floating point, 32-bit floating point, 64-bit floating point, etc.

The fast memory 211 stores an artificial intelligence training workload 213. This workload 213 is usually computationally intense and may run on one or more of the CPU core(s) 203 and/or accelerator core(s) 205. A training workload 213 may include different phases such as data collection and ingestion, data preparation, model training, model evaluation and/or validation, etc. In some examples, the workload 213 utilizes a framework 230 such as PyTorch, Tensorflow, Caffe, Keras, Theano, Deeplearning4j, Sciket-learn, Sonnet, Intel Data Analytics Acceleration Library, Intel Math Kernel Library, JAX, Microsoft Cognitive Toolkit, PlaidML, etc.

A context collector 215 collects context information on tensors (shown as dynamic tensor details 217 and execution context 219). Examples of dynamic tensor details 217 include the identification of the tensor, the size of tensor, a memory address of a tensor used during training (note the memory address is a linear address in some examples and may resolve to fast memory or slow memory), and an execution phase of the AI training workload 213 (e.g., the layer, a timestamp, the pass type (e.g., forward or backward). Examples of execution content 219 includes execution timing information such as a duration of a layer training, a start time for a layer, and/or an end time for a layer.

In some examples, the context collector 215 uses one or more hooks (e.g., a function that attaches a custom function to at least tensors and/or modules within a model) to collect this information. In some examples, the framework provides the hooks. In some examples, the hooks are user supplied. Hooks are triggered at pre-determined phases during training in some examples. In other examples, hooks are called by the training code.

In some examples, at least one forward pre-hook, a forward hook, and a backward hook are utilized during training. In some examples, a forward pre-hook and/or a backward is used to collect context information (e.g., these hooks act as the context collector 215). The forward hook is used to migrate data between memory types.

A forward pre-hook is executed before a forward pass through a module. A forward pre-hook allows for the inspection and/or modification of input data.

A forward hook is executed after a forward pass through a layer, but before the output of the layer. A forward hook allows for the inspection and/or modification of data flowing through a layer the forward pass.

A backward hook is executed during the backward pass through a layer before gradients are calculated. A backward hook allows for the inspection and/or modification of gradients before they are used for weight updates flowing through a layer the backward pass.

Hooks are registered with a module (e.g., model, layer, etc.) and/or tensor (in some examples, only backward hooks may be registered with tensors). The registration allows the training environment (e.g., framework) to call the method(s) of the hooks.

The dynamic tensor details 217 and execution context 219 are used by the tensor migration manager 221 to perform context-aware memory tiering (e.g., for forward and backward passes). The memory tiering uses information from the dynamic tensor details 217 and execution context to determine when to evict a tensor after a forward pass, how much to evict the tensor, and when to prefetch the corresponding evicted tensor during corresponding backward pass.

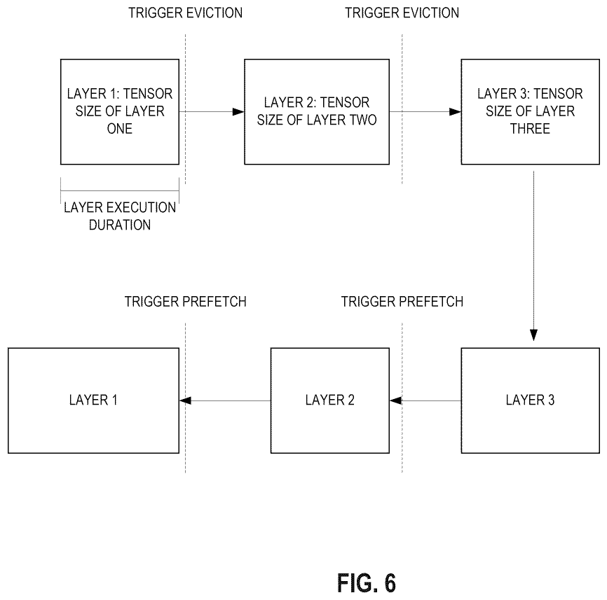

FIG. 6 illustrates examples of timing for eviction and prefetching of a DNN model having 3 layers. The top of FIG. 6 shows timing for eviction. As shown, not all layers take the same time to execute and may have tensors of different sizes. What this illustration shows is that an eviction is triggered when a layer has finished executing. For example, after Layer 1 has finished executing, the entire or partial of the tensor data generated from the execution is migrated, i.e., evicted from a faster memory and stored in a slower memory. Similar data migration happens to Layer 2 execution after Layer 2 execution. In this example, the tensor from Layer 3 is not evicted as it will be used too quickly in its corresponding backward pass.

The bottom shows the prefetching of evicted data from a slower memory to a faster memory for execution during a backward pass. For example, after Layer 3 executes, but before Layer 2 gets executed during the backward pass, the corresponding evicted data after the Layer 2 execution during the forward pass is prefetched from the slower memory to the fast memory. Similarly, before Layer 1's execution during the backward pass, its corresponding evicted data after the Layer 1 execution during the forward pass is prefetched. Again, note that Layer 3 does not need to have a prefetch as its tensor from the Layer 3 execution during the forward pass remains in fast memory.

In some examples, the context aware data migration described above is intra-epoch and in other examples, the migration is inter-epoch. Intra-epoch migration employs memory tiering within an epoch. This migration may be implemented using hooks that get triggered when a tensor is saved in fast memory 211 during the forward pass and will be accessed again during the backward pass. The hooks provide hints through data collection to trigger data movement between the fast memory 211 and slow memory 231. For example, the forward pre-hook is used to collect one or more of the size and memory address of forward pass tensors, the layer identifier, a usage timestamp, an identifier of the tensor, an eviction size (in case the tensor size and eviction size are not the same, and/or a status. The backward hook is used to collect one or more of the size and memory address of backward pass tensors, the layer identifier, a usage timestamp, a predicted time of reuse, an identifier of the tensor, and/or a status. Using this hint information, a calculation of how long it will take to store and retrieve tensors may be made. As backward pass process layers tend to operate in the opposite order of a forward pass process, tensors saved during earlier layers in the forward pass may remain cold for periods of time in fast memory 211 without intervention. As such, these cold tensors take up a limited resource. Using the hooks, the tensor migration manager 221 can move (evict) tensors to slow memory 231 to free up fast memory 211.

When a layer in a forward pass has finished, an eviction determiner 223 decides when to evict data from fast memory 211 based on the information from context collector 215. In some examples, eviction is performed when there is a guarantee that an evicted tensor can be prefetched before it is needed. For example, if it would take 2 minutes to store out a tensor and then retrieve it, but the tensor is needed within 1 minute, there is no guarantee that the tensor would be ready for usage in the backward pass. In some examples, a buffer (or fudge factor) is used as a part of a guarantee. For example, if the tensor in the above example would be needed within 90 seconds and the estimate is that it will take 60 seconds, then, depending on the risk tolerance a guarantee may be made. However, if the risk tolerance is such that 30 seconds is not enough of a fudge factor then a guarantee cannot be made. One or more factors are taken into consideration for eviction such as the size of the data to be evicted, a latency for storage and retrieval (e.g., the round-trip time for storing and retrieval cannot be such that the backward pass layer would be waiting on the retrieval), memory bandwidth utilization (e.g., an estimate of the future bandwidth availability, a current bandwidth availability, etc.), current active layer, current evictions, effective transfer rate, effective prefetch rate, etc. The current active layer, evictions, etc. are maintained by the eviction determiner 223.

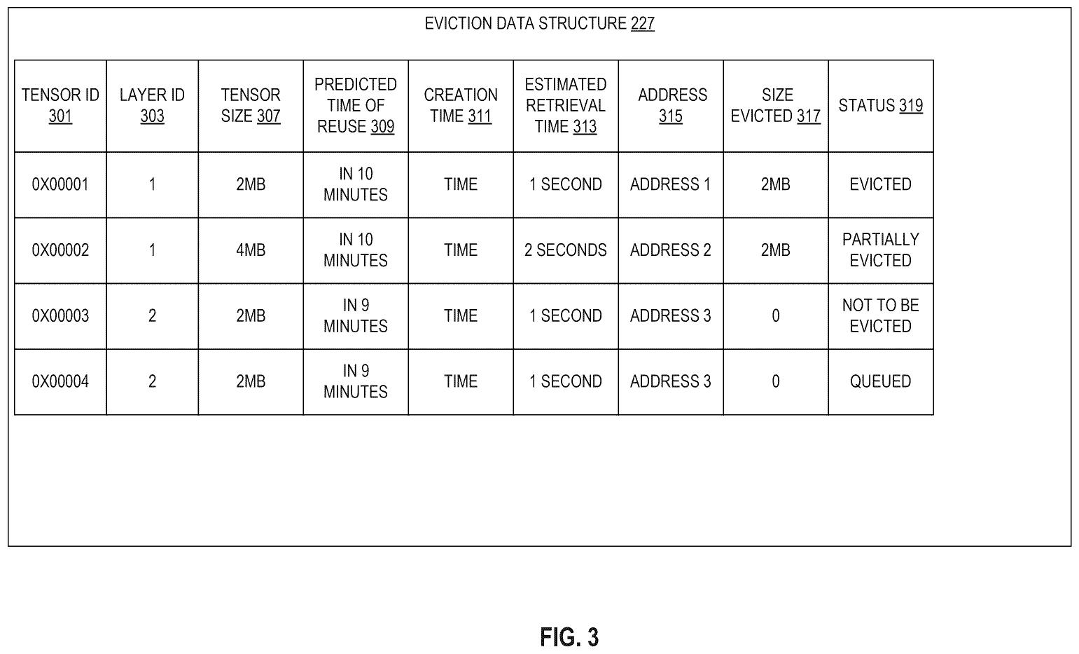

In some examples, an eviction data structure 227 is used to maintain information for one or more of the above eviction factors. In some examples, the eviction determiner 223 maintains this data structure. FIG. 3 illustrates examples of an eviction data structure. Note that in some examples, not all of these fields are present. A tensor identifier (ID) field 301 provides an identifier for a particular tensor. A layer ID 303 indicates what layer the identified tensor is used in. A tensor size field 307 tracks the size of the tensor.

A predicted time of reuse field 309 tracks an estimate of when the tensor will be reused (e.g., when it will be used in a backward pass). A creation time field 311 indicates when the entry was created.

An estimated retrieval time 313 provides an estimate how of long it will take to retrieve a tensor. This time may be generated by looking at bandwidth availability, current prefetches, predicted prefetches, etc.

An address field 315 stores an address of the tensor. In some examples, this address is a virtual address allowing a tensor to have the same address through the training lifecycle.

A size evicted field 317 indicates the amount of the tensor that has been evicted. In some examples, a size of an evictor tensor is related to a cacheline (e.g., the size of multiple cachelines), a page (e.g., the number of pages or a portion thereof), etc. As noted above, in some examples a partial tensor is evicted as is discussed below.

A status field 319 indicates if the tensor is evicted, in a queue to be evicted, or if the tensor is to not be evicted.

In some examples, if the guarantee cannot be met, only a portion of the tensor is evicted. In some examples, if the guarantee cannot be met, then no eviction takes place.

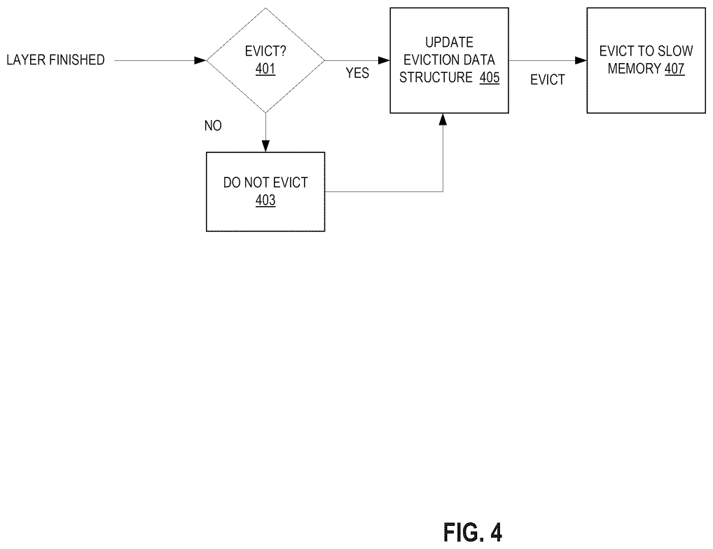

FIG. 4 illustrates examples of an eviction method. In some examples, the method is performed by the context collector 215 and tensor migration manager 221. When a layer has finished its forward pass, a determination is made of if the tensor(s) for the layer is/are to be evicted at 401 based on information collected by the context collector 215 (e.g., by executing a forward pre-hook). For example, can the tensor(s) be guaranteed to be ready when needed by the backward pass? For successful eviction and prefetching, the sum of the prefetch time and eviction time of saved tensors of a layer must be less than an idle time when a tensor is not accessed or a backward pass will have to wait. The maximum size of tensors that can be evicted is related to the idle time (e.g., an amount of time between usage) and the available memory bandwidth (e.g., how long will it take to save and retrieve). If the maximum size is less than the actual size of the tensor to be evicted, only a partial tensor is considered for eviction in some examples.

If the determination is that the tensor(s) should not be evicted, then the tensor(s) is/are saved and not evicted at 403. In some examples, the eviction data structure is updated (e.g., the address of the tensor(s) is/are saved, etc.) at 405.

If the determination is to evict, the eviction data structure is updated (e.g., to reflect the eviction at 405. The tensor(s) is/are evicted to slower memory at 407 (e.g., using a forward pack_hook).

A prefetch determiner 225 uses the eviction data structure 227 to determine when and what to prefetch. A prefetch is triggered to retrieve evicted data before it is needed (e.g., before the layer execution begins in the backward pass). One or more factors are taken into consideration when to trigger the retrieval such as the size of the data to be retrieved, a latency for retrieval, memory bandwidth utilization (e.g., an estimate of the future bandwidth availability, a current bandwidth availability, etc.), a current active layer, current evictions, effective transfer rate, effective prefetch rate, etc.

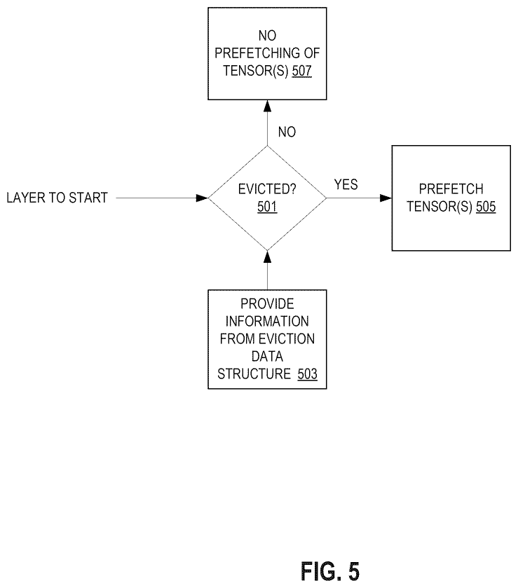

FIG. 5 illustrates examples of a prefetch method. In some examples, the method is performed by the prefetch determiner 225 and/or context collector 215. When a layer is going to start its backward pass, a determination is made if the tensor(s) for the layer is/are has/have been evicted at 501 (e.g., based on information collected by the context collector 215 using a backward hook). This information can be found in the eviction data structure 227 and is provided at 503. The information can be determined using the layer ID, tensor ID, etc.

If the tensor(s) has/have not been evicted, then there is no prefetching to be done at 507. If the tensor(s) has/have been evicted, then the tensor(s) is/are prefetched at 505 (e.g., using a forward unpack-hook). To avoid multiple prefetch transfers, in some examples the prefetch determiner 225 has a counter that tracks when the next prefetch request can be issued. In some examples, the maximum size of the tensor that can be prefetched is related to the time left until the backward pass begins and the available memory bandwidth. The final size of the migrated (evicted) tensor is the minimum of the size computed for eviction and the size computed for prefetch.

A data migrator 228 performs the actual eviction and/or prefetching. The granularity of the eviction and/or prefetch may be cacheline sizes, page(s), etc.

In some examples, the training is performed within a container 212.

In some examples, the context aware data migration described above is inter-epoch (across epochs). Frameworks may implement different memory management strategies for data structure management. For example, in PyTorch tensors are deallocated and the backing memory is freed at the end of an epoch. In TensorFlow tensors and their memory regions are reused across the epochs for the whole duration of the training.

For frameworks that do not deallocate memory across epochs, memory tiering may be used in some examples. In such frameworks, after the completion of the backward pass in epoch tensors are evicted to the slow memory as they are not deallocated, they are prefetched back again before they are accessed in the forward pass of the next epoch. The tensors associated with the final layers may be more amenable to this tiering strategy as they tend to remain cold for longer durations of time.

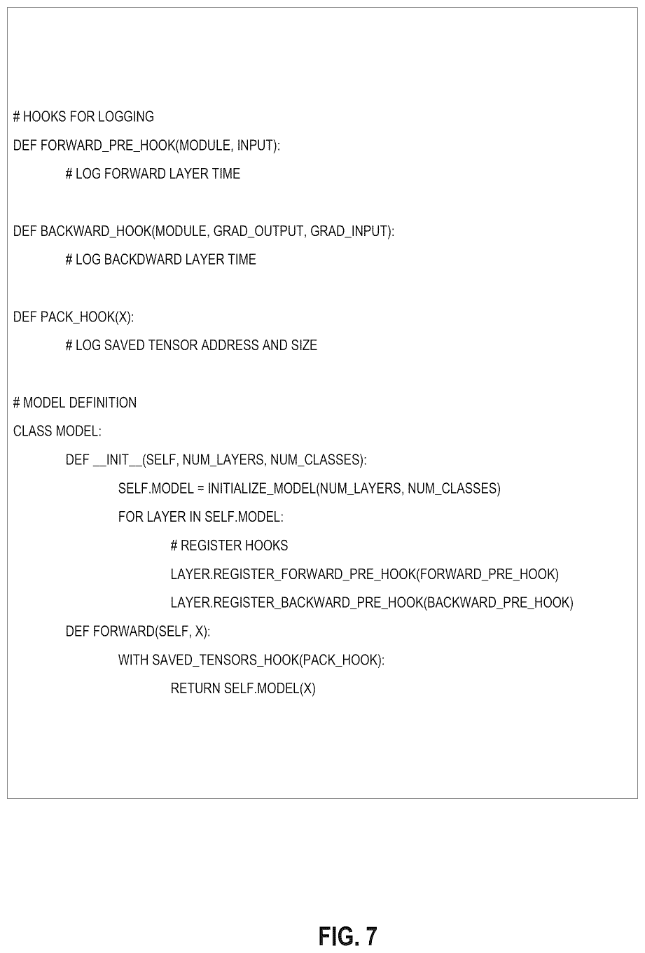

FIGS. 7-10 illustrate examples of code that to register hooks, execute the register hooks and extract context for context-aware memory tiering and examples of hooks for performing this tiering. FIG. 7 illustrates examples of PyTorch code for a model definition including the registration of hooks. As shown, this code defines three hooks—a forward pass pre-hook (forward_pre_hook), a backward pass hook (backward_hook), and a logging (forward) hook (pack_hook).

A model is defined by its layers, classes, etc. For each layer, the forward and backward hooks are registered such that when the layer is being trained, the context collecting, packing (storing out), etc. described above will take place.

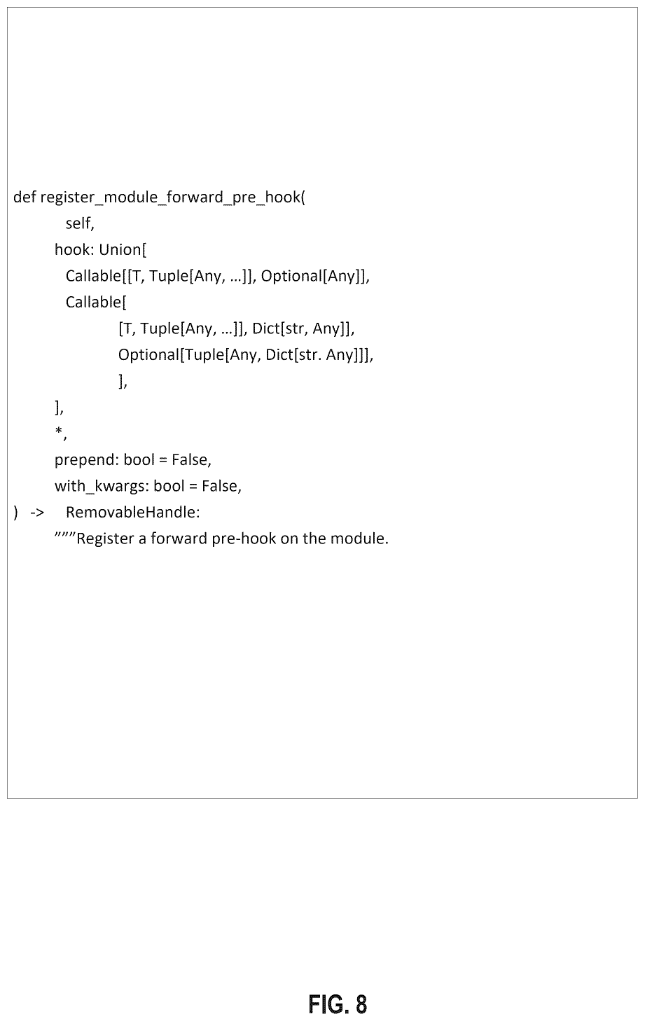

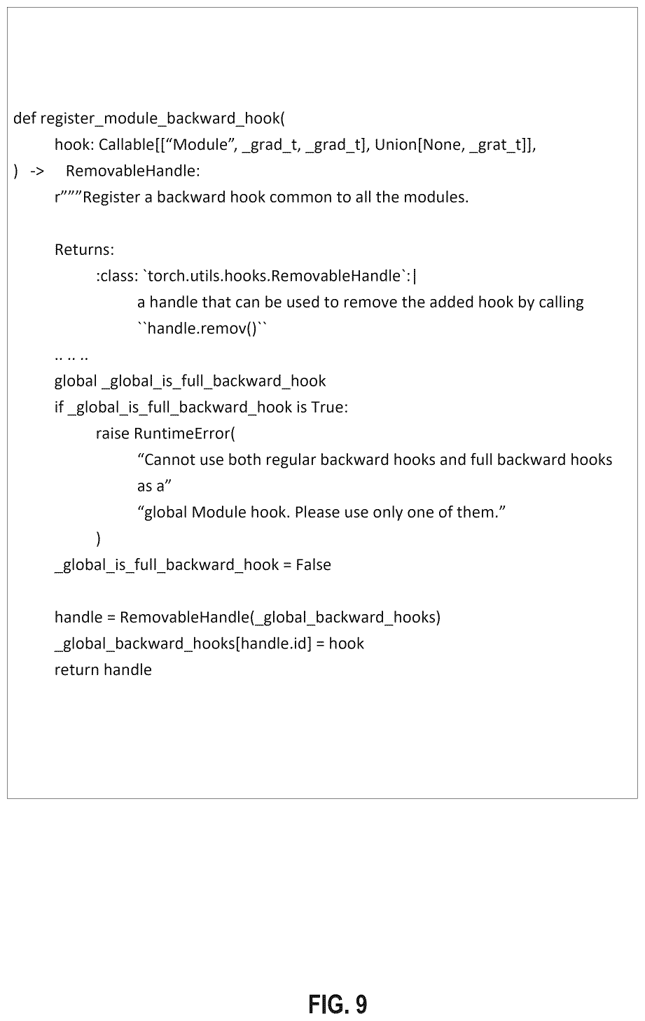

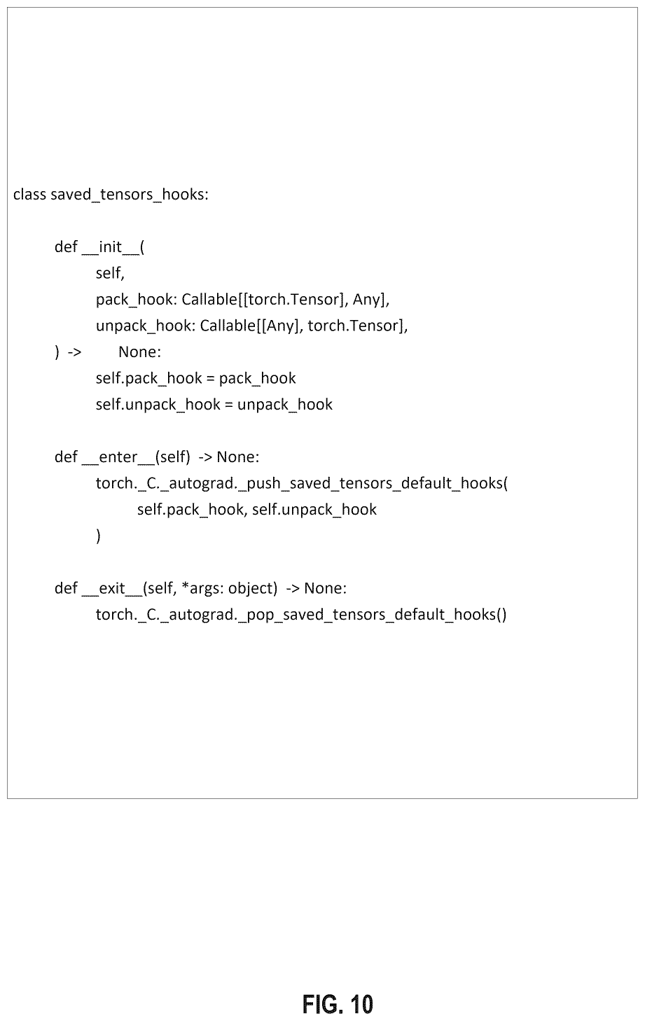

FIG. 8 illustrates examples for PyTorch support for a forward pass hook. FIG. 9 illustrates examples for PyTorch support for a backward pass hook. FIG. 10 illustrates examples for PyTorch support for storing tensors and retrieving tensors. In this code, the “push” is a save (it packs a tensor), and the “pop” is a retrieval of a tensor (it unpacks a tensor).

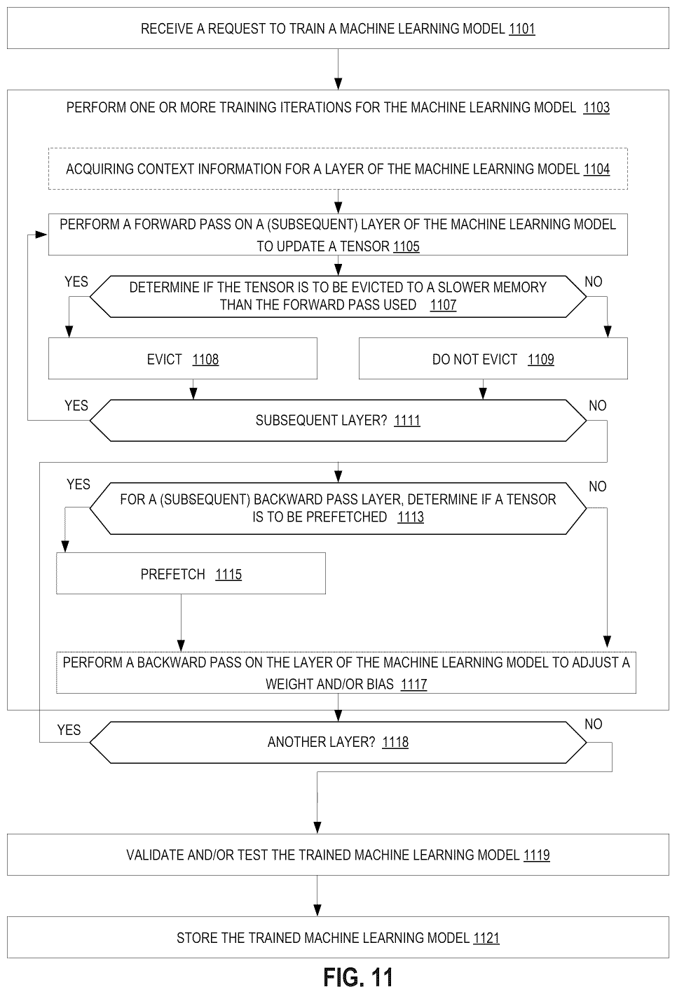

FIG. 11 is a flow diagram illustrating operations of a method for training a machine learning model according to some examples. Some or all of the operations (or other processes described herein, or variations, and/or combinations thereof) are performed under the control of one or more computing devices configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some examples, the training is performed using a service of a cloud provider network. In some examples, the method is performed using a core of a CPU. In some examples, the method is performed using a core of an accelerator.

A request to train a machine learning model is received at 1101 in some examples. This request may include one or more of an identifier of a machine learning model to train, an identifier of a machine learning algorithm to train, an identifier of a machine learning model to fine-tune, an indication of a location for training data (e.g., stored in a storage service 1305, locally, etc.), an indication of a location for validation and/or testing data (e.g., stored in a storage service 1305, locally, etc.), an indication of where to store artifacts generated by the training of the machine learning model (e.g., stored in a storage service 1305, locally, etc.), an indication of the compute instance to use for training (e.g., which instance of compute service(s) 1303, model training service(s) 1307, etc.), a training program (e.g., Python code), etc.

One or more training iterations for the machine learning model is/are performed at 1103. In some examples, there are one or more forward passes through the layers of the model and an equal number of backward passes through those layers. In some examples, each forward and backward pass combination is an epoch. Context information for a layer of the machine learning model is acquired in some examples at 1104. For example, a forward pre-hook is invoked to gather this information.

A forward pass is performed on a layer of the machine learning model to update a tensor at 1105 where the tensor is the output of the layer. The calculation of the tensor may use one of the data types detailed above. In some examples, a forward pre-hook is called to gather this information after the layer has been executed, but before the next layer is executed.

A determination of if the tensor is to be evicted to a slower memory after the forward pass used at 1107 using the context information. For example, is there a guarantee that if the tensor is evicted to slower memory that it can be retrieved before it is needed in a backward pass for this layer? Examples of what goes into this determination are detailed above.

If the tensor is to be evicted, then it is evicted at 1108. This eviction could be to slower memory such as a solid state disk, a magnetic disk, etc. In some examples, a forward hook (e.g., pack_hook) is used to evict. This hook also supplied context information (e.g., size of a tensor) to the after the forward layer. If the determination is to not evict, then no eviction takes place at 1109. Note that, in some examples, an eviction data structure (e.g., eviction data structure 227) is updated regardless of if the tensor is evicted.

A determination of if there is a subsequent layer to perform a forward pass on is made at 1111. If there is, then the forward pass for that subsequent layer is performed at 1105.

If there is not a subsequent layer to perform a forward pass on, then the backward pass portion of the iteration can occur. For a backward pass layer, a determination is made of if a tensor is to be prefetched is made at 1113. For example, is there an indication in an eviction data structure that prefetching for this backward pass layer is to occur. If a tensor is to be prefetched, it is prefetched at 1115. In some examples, a hook (e.g., unpack_hook) is used to prefetch. If a tensor is not to be prefetched (it is already in memory), or after the tensor is prefetched, a backward pass is performed on the layer of the machine learning model to adjust a weight and/or bias at 1117.

A determination of if there is a subsequent layer to process in the backward pass portion is made at 1118. If yes, the subsequent backward pass layer, a determination is made of if a tensor is to be prefetched is made at 1113, etc. Note that only one training iteration (epoch) is shown, but multiple iterations may be performed. In some examples, when the training has completed, the trained machine learning model is validated and/or tested at 1119. The validation and/or testing may use data indicated by the request. The trained machine learning model is stored at 1121.

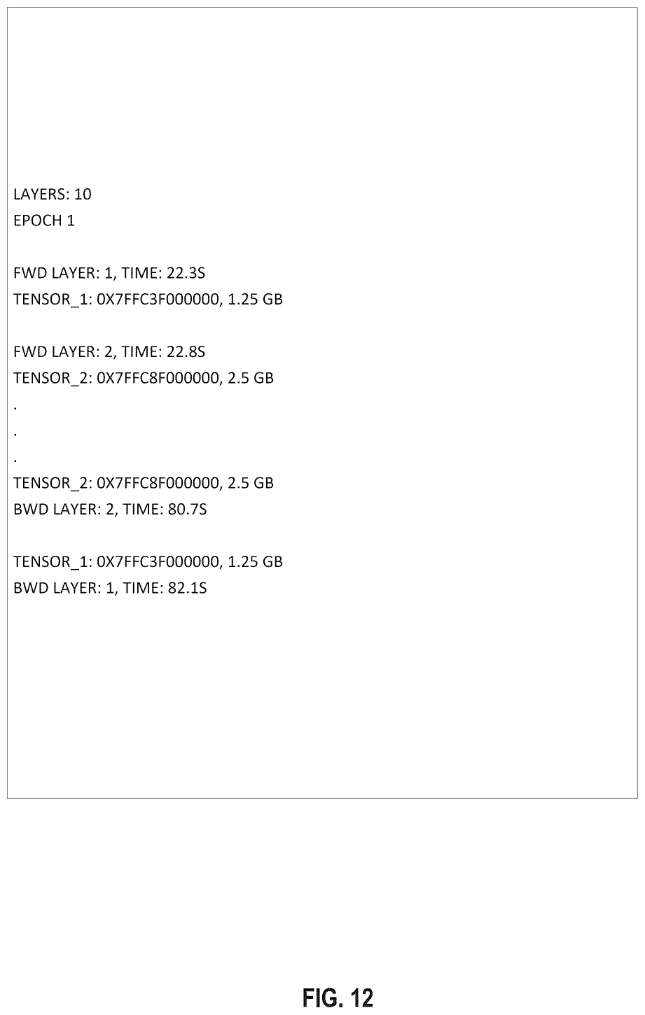

FIG. 12 illustrates examples training output. In this example, the ML model has 10 layers. In the first epoch, the first forward layer took 22.3 seconds to complete and the tensor generated by this layer was 1.25 GB in size. The second forward layer took longer to complete and generated an even larger tensor. These tensors have both been migrated to slower memory. Each of these tensors was prefetched before their respective layer's execution.

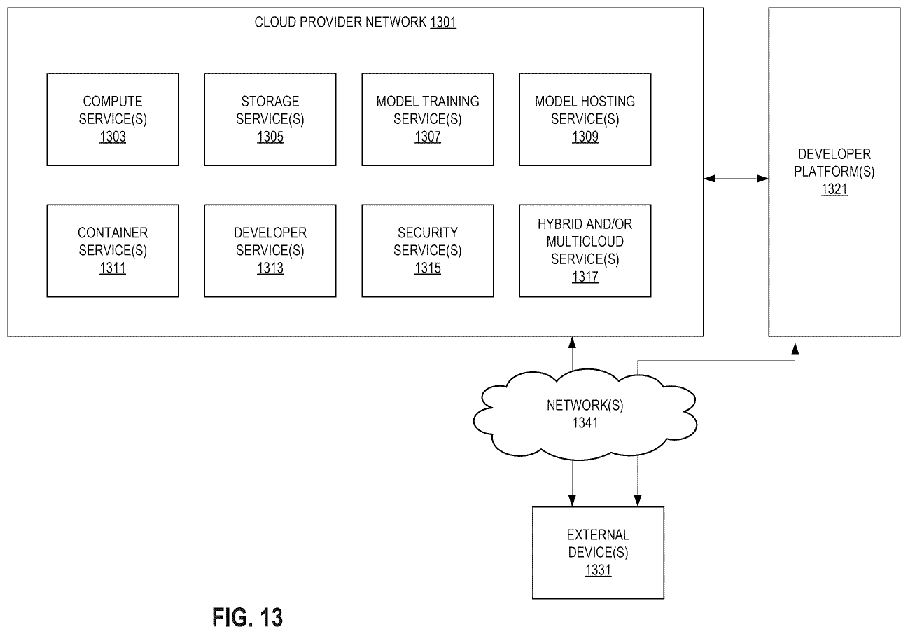

In some examples, a cloud provider network provides a service that allows for DNN training as detailed above. FIG. 13 illustrates examples of a cloud provider network. The example cloud provider network 1301 includes a plurality of services.

In some examples, one or more compute services 1303 provide cloud compute capacity, virtualization, and scaling. In some examples, one or more of these services allows for the containerization of applications, deployment to virtual machines (VMs), etc. These compute services support a plurality of different instance types (e.g., CPU, GPU, accelerators, etc.) and/or memory support (e.g., an amount of RAM, etc.). In some examples, the compute services support a dedicated host, container hosting, a compute fleet, OS servers, etc.

In some examples, one or more storage services 1305 provide cloud storage. For example, these storage services may include databases, disk storage, blob storage, data lake storage, file syncing with on-premises data, container storage, etc.

In some examples, one or more model training services 1307 provide support for training of a ML model. In some examples, the DNN training described above is supported through a command line interface or graphical user interface input. The model training services support one or more of bot development, searching, model training, model validation, computer vision, etc.

In some examples, one or more model hosting services 1309 allow for a trained model to be deployed and hosted within the cloud provider network.

In some examples, one or more container services 1311 support the development and deployment of containerized software. In some examples, these services include a registry to build, store, secure, and/or replicate containers. In some examples, these services support storage for containers.

In some examples, one or more developer services 1313 support the development of code. For example, these services may provide an integrated development environment (IDE), code debugging, software development kits (SDKs), load testing, code generation, etc.

In some examples, one or more security services 1315 protect applications, data, and/or cloud infrastructure. These services may include threat protection, cryptographic key management, denial of service protection, information protection (e.g., protecting emails, documents, etc.), attestation of trusted execution environments, etc.

In some examples, one or more hybrid and/or multi-cloud services 1317 allow for the synchronization of cloud and on-premises directories, data, etc. These services may also provide for running local VMs, containers, and cloud provider network services.

Developer platform(s) 1321 allow for storage, editing, etc. of software development projects. In some examples, code for DNN training may be stored using a developer platform.

External device(s) 1331 connect to the cloud provider network 1301 and/or developer platform(s) 1321 through one or more networks 1341.

Examples detailed above may be implemented using one or more architectures, CPUs, GPUs, etc. Detailed below are examples of apparatuses, systems, systems-on-chip, etc. in which examples detailed above may be implemented.

### Example Architectures

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

### Example Systems

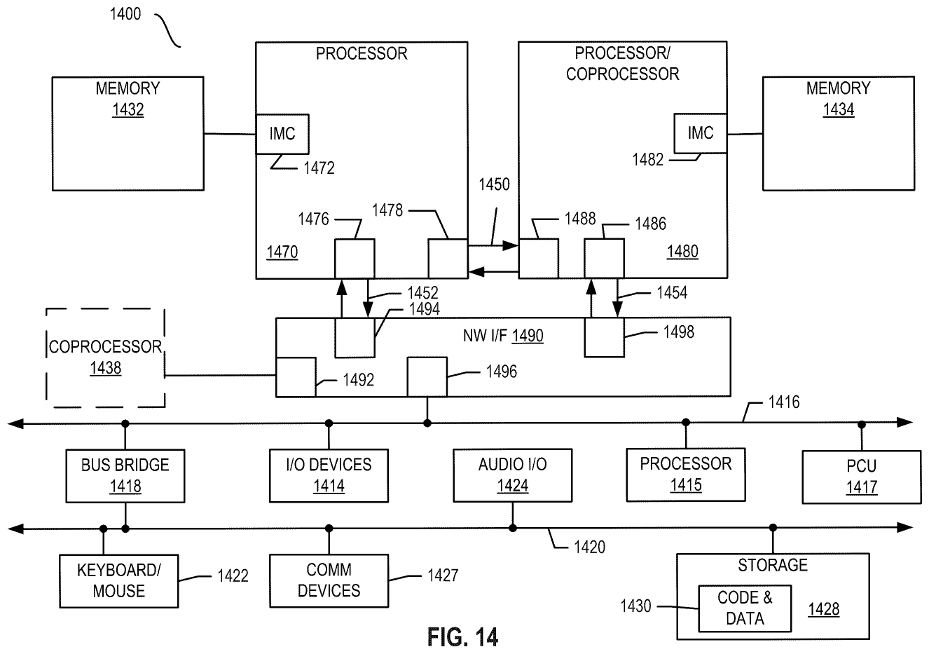

FIG. 14 illustrates an example computing system. Multiprocessor system 1400 is an interfaced system and includes a plurality of processors or cores including a first processor 1470 and a second processor 1480 coupled via an interface 1450 such as a point-to-point (P-P) interconnect, a fabric, and/or bus. In some examples, the first processor 1470 and the second processor 1480 are homogeneous. In some examples, first processor 1470 and the second processor 1480 are heterogenous. Though the example multiprocessor system 1400 is shown to have two processors, the system may have three or more processors, or may be a single processor system. In some examples, the computing system is a system on a chip (SoC).

Processors 1470 and 1480 are shown including integrated memory controller (IMC) circuitry 1472 and 1482, respectively. Processor 1470 also includes interface circuits 1476 and 1478; similarly, second processor 1480 includes interface circuits 1486 and 1488. Processors 1470, 1480 may exchange information via the interface 1450 using interface circuits 1478, 1488. IMCs 1472 and 1482 couple the processors 1470, 1480 to respective memories, namely a memory 1432 and a memory 1434, which may be portions of main memory locally attached to the respective processors.

Processors 1470, 1480 may each exchange information with a network interface (NW I/F) 1490 via individual interfaces 1452, 1454 using interface circuits 1476, 1494, 1486, 1498. The network interface 1490 (e.g., one or more of an interconnect, bus, and/or fabric, and in some examples is a chipset) may optionally exchange information with a co-processor 1438 via an interface circuit 1492. In some examples, the co-processor 1438 is a special-purpose processor, such as, for example, a high-throughput processor, a network or communication processor, a compression engine, a graphics processor, a general purpose graphics processing unit (GPGPU), a neural-network processing unit (NPU), an embedded processor, a security processor, a cryptographic accelerator, a matrix accelerator, an in-memory analytics accelerator, a data streaming accelerator, data graph operations, or the like.

A shared cache (not shown) may be included in either processor 1470, 1480 or outside of both processors, yet connected with the processors via an interface such as P-P interconnect, such that either or both processors' local cache information may be stored in the shared cache if a processor is placed into a low power mode.

Network interface 1490 may be coupled to a first interface 1416 via interface circuit 1496. In some examples, first interface 1416 may be an interface such as a Peripheral Component Interconnect (PCI) interconnect, a PCI Express interconnect or another I/O interconnect. In some examples, first interface 1416 is coupled to a power control unit (PCU) 1417, which may include circuitry, software, and/or firmware to perform power management operations with regard to the processors 1470, 1480 and/or co-processor 1438. PCU 1417 provides control information to a voltage regulator (not shown) to cause the voltage regulator to generate the appropriate regulated voltage. PCU 1417 also provides control information to control the operating voltage generated. In various examples, PCU 1417 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1417 is illustrated as being present as logic separate from the processor 1470 and/or processor 1480. In other cases, PCU 1417 may execute on a given one or more of cores (not shown) of processor 1470 or 1480. In some cases, PCU 1417 may be implemented as a microcontroller (dedicated or general-purpose) or other control logic configured to execute its own dedicated power management code, sometimes referred to as P-code. In yet other examples, power management operations to be performed by PCU 1417 may be implemented externally to a processor, such as by way of a separate power management integrated circuit (PMIC) or another component external to the processor. In yet other examples, power management operations to be performed by PCU 1417 may be implemented within BIOS or other system software.

Various I/O devices 1414 may be coupled to first interface 1416, along with a bus bridge 1418 which couples first interface 1416 to a second interface 1420. In some examples, one or more additional processor(s) 1415, such as co-processors, high throughput many integrated core (MIC) processors, GPGPUs, accelerators (such as graphics accelerators or digital signal processing (DSP) units), field programmable gate arrays (FPGAs), or any other processor, are coupled to first interface 1416. In some examples, second interface 1420 may be a low pin count (LPC) interface. Various devices may be coupled to second interface 1420 including, for example, a keyboard and/or mouse 1422, communication devices 1427 and storage circuitry 1428. Storage circuitry 1428 may be one or more non-transitory machine-readable storage media as described below, such as a disk drive or other mass storage device which may include instructions/code and data 1430 and may implement the storage ‘ISAB03 in some examples. Further, an audio I/O 1424 may be coupled to second interface 1420. Note that other architectures than the point-to-point architecture described above are possible. For example, instead of the point-to-point architecture, a system such as multiprocessor system 1400 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a co-processor including one or more special purpose cores intended primarily for graphics and/or scientific (throughput) computing. Such different processors lead to different computer system architectures, which may include: 1) the co-processor on a separate chip from the CPU; 2) the co-processor on a separate die in the same package as a CPU; 3) the co-processor on the same die as a CPU (in which case, such a co-processor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described co-processor, and additional functionality. Example core architectures are described next, followed by descriptions of example processors and computer architectures.

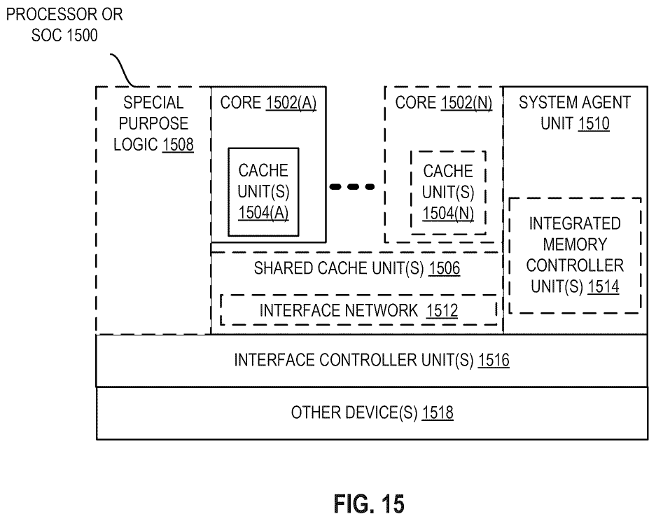

FIG. 15 illustrates a block diagram of an example processor and/or SoC 1500 that may have one or more cores and an integrated memory controller. The solid lined boxes illustrate a processor and/or SoC 1500 with a single core 1502(A), system agent unit circuitry 1510, and a set of one or more interface controller unit(s) circuitry 1516, while the optional addition of the dashed lined boxes illustrates an alternative processor and/or SoC 1500 with multiple cores 1502(A)-(N), a set of one or more integrated memory controller unit(s) circuitry 1514 in the system agent unit circuitry 1510, and special purpose logic 1508, as well as a set of one or more interface controller unit(s) circuitry 1516. Note that the processor and/or SoC 1500 may be one of the processors 1470 or 1480, or co-processor 1438 or 1415 of FIG. 14.

Thus, different implementations of the processor and/or SoC 1500 may include: 1) a CPU with the special purpose logic 1508 being a high-throughput processor, a network or communication processor, a compression engine, a graphics processor, a general purpose graphics processing unit (GPGPU), a neural-network processing unit (NPU), an embedded processor, a security processor, a matrix accelerator, an in-memory analytics accelerator, a compression accelerator, a data streaming accelerator, data graph operations, or the like (which may include one or more cores, not shown), and the cores 1502(A)-(N) being one or more general purpose cores (e.g., general purpose in-order cores, general purpose out-of-order cores, or a combination of the two); 2) a co-processor with the cores 1502(A)-(N) being a large number of special purpose cores intended primarily for graphics and/or scientific (throughput); and 3) a co-processor with the cores 1502(A)-(N) being a large number of general purpose in-order cores. Thus, the processor and/or SoC 1500 may be a general-purpose processor, co-processor or special-purpose processor, such as, for example, a network or communication processor, compression engine, graphics processor, GPGPU (general purpose graphics processing unit), a high throughput many integrated core (MIC) co-processor (including 30 or more cores), embedded processor, or the like. The processor may be implemented on one or more chips. The processor and/or SoC 1500 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1504(A)-(N) within the cores 1502(A)-(N), a set of one or more shared cache unit(s) circuitry 1506, and external memory (not shown) coupled to the set of integrated memory controller unit(s) circuitry 1514. The set of one or more shared cache unit(s) circuitry 1506 may include one or more mid-level caches, such as level 2 (L2), level 3 (L3), level 4 (L4), or other levels of cache, such as a last level cache (LLC), and/or combinations thereof. While in some examples interface network circuitry 1512 (e.g., a ring interconnect) interfaces the special purpose logic 1508 (e.g., integrated graphics logic), the set of shared cache unit(s) circuitry 1506, and the system agent unit circuitry 1510, alternative examples use any number of well-known techniques for interfacing such units. In some examples, coherency is maintained between one or more of the shared cache unit(s) circuitry 1506 and cores 1502(A)-(N). In some examples, interface controller unit(s) circuitry 1516 couple the cores 1502(A)-(N) to one or more other devices 1518 such as one or more I/O devices, storage, one or more communication devices (e.g., wireless networking, wired networking, etc.), etc.

In some examples, one or more of the cores 1502(A)-(N) are capable of multi-threading. The system agent unit circuitry 1510 includes those components coordinating and operating cores 1502(A)-(N). The system agent unit circuitry 1510 may include, for example, power control unit (PCU) circuitry and/or display unit circuitry (not shown). The PCU may be or may include logic and components needed for regulating the power state of the cores 1502(A)-(N) and/or the special purpose logic 1508 (e.g., integrated graphics logic). The display unit circuitry is for driving one or more externally connected displays.

The cores 1502(A)-(N) may be homogenous in terms of instruction set architecture (ISA). Alternatively, the cores 1502(A)-(N) may be heterogeneous in terms of ISA; that is, a subset of the cores 1502(A)-(N) may be capable of executing an ISA, while other cores may be capable of executing only a subset of that ISA or another ISA.

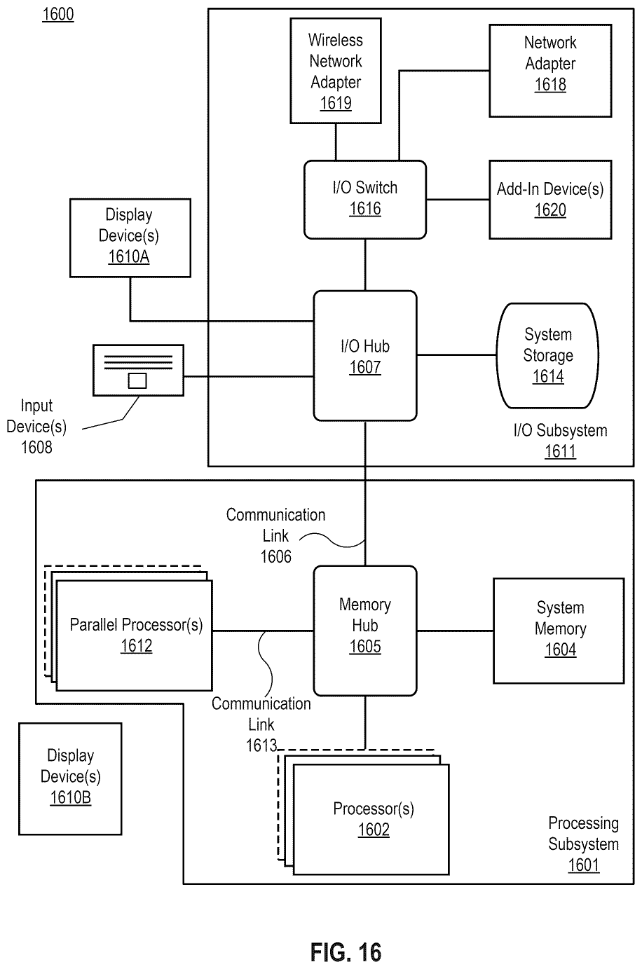

FIG. 16 is a block diagram illustrating a computing system 1600 configured to implement one or more aspects of the examples described herein. The computing system 1600 includes a processing subsystem 1601 having one or more processor(s) 1602 and a system memory 1604 communicating via an interconnection path that may include a memory hub 1605. The memory hub 1605 may be a separate component within a chipset component or may be integrated within the one or more processor(s) 1602. The memory hub 1605 couples with an I/O subsystem 1611 via a communication link 1606. The I/O subsystem 1611 includes an I/O hub 1607 that can enable the computing system 1600 to receive input from one or more input device(s) 1608. Additionally, the I/O hub 1607 can enable a display controller, which may be included in the one or more processor(s) 1602, to provide outputs to one or more display device(s) 1610A. In some examples the one or more display device(s) 1610A coupled with the I/O hub 1607 can include a local, internal, or embedded display device.

The processing subsystem 1601, for example, includes one or more parallel processor(s) 1612 coupled to memory hub 1605 via a bus or communication link 1613. The communication link 1613 may be one of any number of standards-based communication link technologies or protocols, such as, but not limited to PCI Express, or may be a vendor specific communications interface or communications fabric. The one or more parallel processor(s) 1612 may form a computationally focused parallel or vector processing system that can include a large number of processing cores and/or processing clusters, such as a many integrated core (MIC) processor. For example, the one or more parallel processor(s) 1612 form a graphics processing subsystem that can output pixels to one of the one or more display device(s) 1610A coupled via the I/O hub 1607. The one or more parallel processor(s) 1612 can also include a display controller and display interface (not shown) to enable a direct connection to one or more display device(s) 1610B.

Within the I/O subsystem 1611, a system storage unit 1614 can connect to the I/O hub 1607 to provide a storage mechanism for the computing system 1600. An I/O switch 1616 can be used to provide an interface mechanism to enable connections between the I/O hub 1607 and other components, such as a network adapter 1618 and/or wireless network adapter 1619 that may be integrated into the platform, and various other devices that can be added via one or more add-in device(s) 1620. The add-in device(s) 1620 may also include, for example, one or more external graphics processor devices, graphics cards, and/or compute accelerators. The network adapter 1618 can be an Ethernet adapter or another wired network adapter. The wireless network adapter 1619 can include one or more of a Wi-Fi, Bluetooth, near field communication (NFC), or other network device that includes one or more wireless radios.

The computing system 1600 can include other components not explicitly shown, including USB or other port connections, optical storage drives, video capture devices, and the like, which may also be connected to the I/O hub 1607. Communication paths interconnecting the various components in FIG. 16 may be implemented using any suitable protocols, such as PCI (Peripheral Component Interconnect) based protocols (e.g., PCI-Express), or any other bus or point-to-point communication interfaces and/or protocol(s), such as the NVLink high-speed interconnect, Compute Express Link™ (CXL™) (e.g., CXL.mem), Infinity Fabric (IF), Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (ROCE), Intel QuickPath Interconnect (QPI), Intel Ultra Path Interconnect (UPI), Intel On-Chip System Fabric (IOSF), Omnipath, HyperTransport, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof, or wired or wireless interconnect protocols known in the art. In some examples, data can be copied or stored to virtualized storage nodes using a protocol such as non-volatile memory express (NVMe) over Fabrics (NVMe-oF) or NVMe.

The one or more parallel processor(s) 1612 may incorporate circuitry optimized for graphics and video processing, including, for example, video output circuitry, and constitutes a graphics processing unit (GPU). Alternatively or additionally, the one or more parallel processor(s) 1612 can incorporate circuitry optimized for general purpose processing, while preserving the underlying computational architecture, described in greater detail herein. Components of the computing system 1600 may be integrated with one or more other system elements on a single integrated circuit. For example, the one or more parallel processor(s) 1612, memory hub 1605, processor(s) 1602, and I/O hub 1607 can be integrated into a system on chip (SoC) integrated circuit. Alternatively, the components of the computing system 1600 can be integrated into a single package to form a system in package (SIP) configuration. In some examples at least a portion of the components of the computing system 1600 can be integrated into a multi-chip module (MCM), which can be interconnected with other multi-chip modules into a modular computing system.

It will be appreciated that the computing system 1600 shown herein is illustrative and that variations and modifications are possible. The connection topology, including the number and arrangement of bridges, the number of processor(s) 1602, and the number of parallel processor(s) 1612, may be modified as desired. For instance, system memory 1604 can be connected to the processor(s) 1602 directly rather than through a bridge, while other devices communicate with system memory 1604 via the memory hub 1605 and the processor(s) 1602. In other alternative topologies, the parallel processor(s) 1612 are connected to the I/O hub 1607 or directly to one of the one or more processor(s) 1602, rather than to the memory hub 1605. In other examples, the I/O hub 1607 and memory hub 1605 may be integrated into a single chip. It is also possible that two or more sets of processor(s) 1602 are attached via multiple sockets, which can couple with two or more instances of the parallel processor(s) 1612.

Some of the particular components shown herein are optional and may not be included in all implementations of the computing system 1600. For example, any number of add-in cards or peripherals may be supported, or some components may be eliminated. Furthermore, some architectures may use different terminology for components similar to those illustrated in FIG. 16. For example, the memory hub 1605 may be referred to as a Northbridge in some architectures, while the I/O hub 1607 may be referred to as a Southbridge.

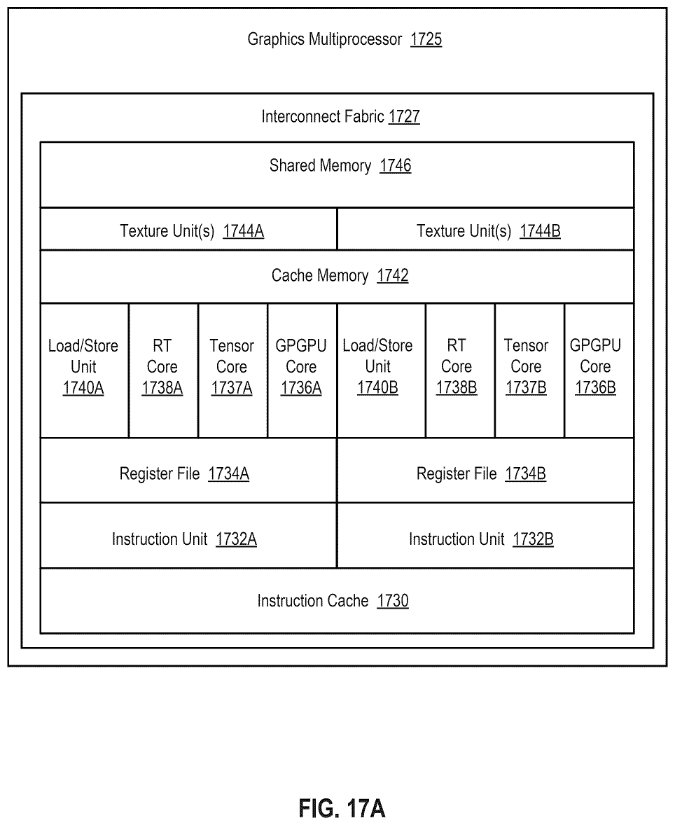

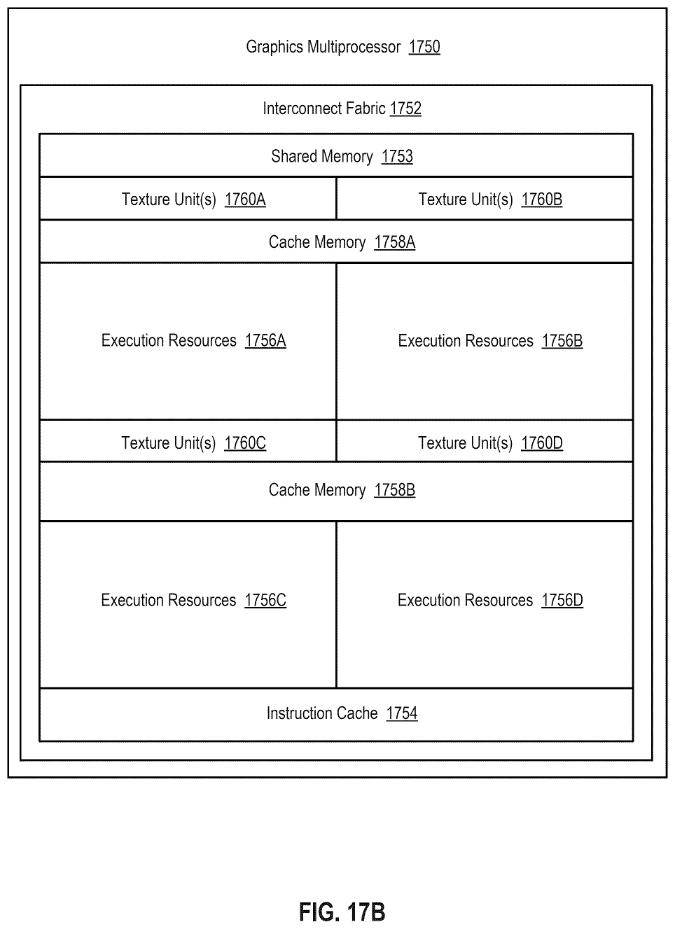

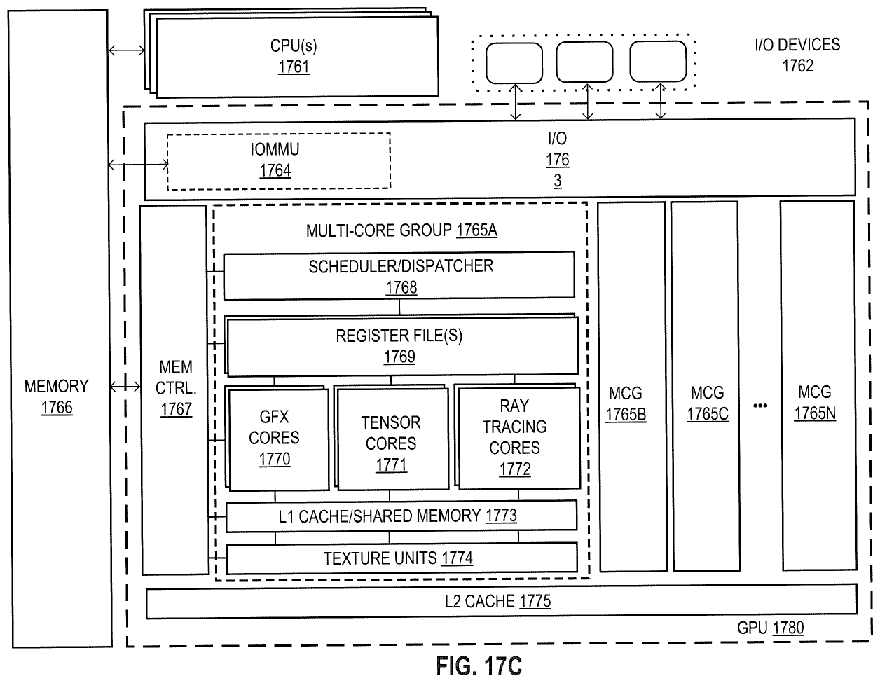

FIGS. 17A-17C illustrate additional graphics multiprocessors, according to examples. FIG. 17A-17B illustrate graphics multiprocessors 1725, 1750. FIG. 17C illustrates a graphics processing unit (GPU) 1780 which includes dedicated sets of graphics processing resources arranged into multi-core groups 1765A-1765N, which correspond to the graphics multiprocessors 1725, 1750. The illustrated graphics multiprocessors 1725, 1750 and the multi-core groups 1765A-1765N can be streaming multiprocessors (SM) capable of simultaneous execution of a large number of execution threads.

The graphics multiprocessor 1725 of FIG. 17A includes multiple additional instances of execution resource units relative to the graphics multiprocessor. For example, the graphics multiprocessor 1725 can include multiple instances of the instruction unit 1732A-1732B, register file 1734A-1734B, and texture unit(s) 1744A-1744B. The graphics multiprocessor 1725 also includes multiple sets of graphics or compute execution units (e.g., GPGPU core 1736A-1736B, tensor core 1737A-1737B, ray-tracing core 1738A-1738B) and multiple sets of load/store units 1740A-1740B. The execution resource units have a common instruction cache 1730, texture and/or data cache memory 1742, and shared memory 1746.

The various components can communicate via an interconnect fabric 1727. The interconnect fabric 1727 may include one or more crossbar switches to enable communication between the various components of the graphics multiprocessor 1725. The interconnect fabric 1727 may be a separate, high-speed network fabric layer upon which each component of the graphics multiprocessor 1725 is stacked. The components of the graphics multiprocessor 1725 communicate with remote components via the interconnect fabric 1727. For example, the cores 1736A-1736B, 1737A-1737B, and 1738A-1738B can each communicate with shared memory 1746 via the interconnect fabric 1727. The interconnect fabric 1727 can arbitrate communication within the graphics multiprocessor 1725 to ensure a fair bandwidth allocation between components.

The graphics multiprocessor 1750 of FIG. 17B includes multiple sets of execution resources 1756A-1756D, where each set of execution resource includes multiple instruction units, register files, GPGPU cores, and load store units, as illustrated in FIG. 17A. The execution resources 1756A-1756D can work in concert with texture unit(s) 1760A-1760D for texture operations, while sharing an instruction cache 1754, and shared memory 1753. For example, the execution resources 1756A-1756D can share an instruction cache 1754 and shared memory 1753, as well as multiple instances of a texture and/or data cache memory 1758A-1758B. The various components can communicate via an interconnect fabric 1752 similar to the interconnect fabric 1727 of FIG. 17A.

Persons skilled in the art will understand that the architecture described in FIGS. 1 and 17A-17B are descriptive and not limiting as to the scope of the present examples. Thus, the techniques described herein may be implemented on any properly configured processing unit, including, without limitation, one or more mobile application processors, one or more desktop or server central processing units (CPUs) including multi-core CPUs, one or more parallel processing units, as well as one or more graphics processors or special purpose processing units, without departure from the scope of the examples described herein.

The parallel processor or GPGPU as described herein may be communicatively coupled to host/processor cores to accelerate graphics operations, machine-learning operations, pattern analysis operations, and various general-purpose GPU (GPGPU) functions. The GPU may be communicatively coupled to the host processor/cores over a bus or other interconnect (e.g., a high-speed interconnect such as PCIe, NVLink, or other known protocols, standardized protocols, or proprietary protocols). In other examples, the GPU may be integrated on the same package or chip as the cores and communicatively coupled to the cores over an internal processor bus/interconnect (i.e., internal to the package or chip). Regardless of the manner in which the GPU is connected, the processor cores may allocate work to the GPU in the form of sequences of commands/instructions contained in a work descriptor. The GPU then uses dedicated circuitry/logic for efficiently processing these commands/instructions.

FIG. 17C illustrates a graphics processing unit (GPU) 1780 which includes dedicated sets of graphics processing resources arranged into multi-core groups 1765A-1765N. While the details of only a single multi-core group 1765A are provided, it will be appreciated that the other multi-core groups 1765B-1765N may be equipped with the same or similar sets of graphics processing resources. Details described with respect to the multi-core groups 1765A-1765N may also apply to any graphics multiprocessor 1725, 1750, etc. described herein.

As illustrated, a multi-core group 1765A may include a set of graphics cores 1770, a set of tensor cores 1771, and a set of ray tracing cores 1772. A scheduler/dispatcher 1768 schedules and dispatches the graphics threads for execution on the various cores 1770, 1771, 1772. A set of register files 1769 store operand values used by the cores 1770, 1771, 1772 when executing the graphics threads. These may include, for example, integer registers for storing integer values, floating point registers for storing floating point values, vector registers for storing packed data elements (integer and/or floating-point data elements) and tile registers for storing tensor/matrix values. The tile registers may be implemented as combined sets of vector registers.

One or more combined level 1 (L1) caches and shared memory units 1773 store graphics data such as texture data, vertex data, pixel data, ray data, bounding volume data, etc., locally within each multi-core group 1765A. One or more texture units 1774 can also be used to perform texturing operations, such as texture mapping and sampling. A Level 2 (L2) cache 1775 shared by all or a subset of the multi-core groups 1765A-1765N stores graphics data and/or instructions for multiple concurrent graphics threads. As illustrated, the L2 cache 1775 may be shared across a plurality of multi-core groups 1765A-1765N. One or more memory controllers 1767 couple the GPU 1780 to a memory 1766 which may be a system memory (e.g., DRAM) and/or a dedicated graphics memory (e.g., GDDR6 memory).

Input/output (I/O) circuitry 1763 couples the GPU 1780 to one or more I/O devices 1762 such as digital signal processors (DSPs), network controllers, or user input devices. An on-chip interconnect may be used to couple the I/O devices 1762 to the GPU 1780 and memory 1766. One or more I/O memory management units (IOMMUs) 1764 of the I/O circuitry 1763 couple the I/O devices 1762 directly to the system memory 1766. Optionally, the IOMMU 1764 manages multiple sets of page tables to map virtual addresses to physical addresses in system memory 1766. The I/O devices 1762, CPU(s) 1761, and GPU(s) 1780 may then share the same virtual address space.

In one implementation of the IOMMU 1764, the IOMMU 1764 supports virtualization. In this case, it may manage a first set of page tables to map guest/graphics virtual addresses to guest/graphics physical addresses and a second set of page tables to map the guest/graphics physical addresses to system/host physical addresses (e.g., within system memory 1766). The base addresses of each of the first and second sets of page tables may be stored in control registers and swapped out on a context switch (e.g., so that the new context is provided with access to the relevant set of page tables). While not illustrated in FIG. 17C, each of the cores 1770, 1771, 1772 and/or multi-core groups 1765A-1765N may include translation lookaside buffers (TLBs) to cache guest virtual to guest physical translations, guest physical to host physical translations, and guest virtual to host physical translations.

The CPU(s) 1761, GPUs 1780, and I/O devices 1762 may be integrated on a single semiconductor chip and/or chip package. The illustrated memory 1766 may be integrated on the same chip or may be coupled to the memory controllers 1767 via an off-chip interface. In one implementation, the memory 1766 comprises GDDR6 memory which shares the same virtual address space as other physical system-level memories, although the underlying principles described herein are not limited to this specific implementation.

The tensor cores 1771 may include a plurality of execution units specifically designed to perform matrix operations, which are the fundamental compute operation used to perform deep learning operations. For example, simultaneous matrix multiplication operations may be used for neural network training and inferencing. The tensor cores 1771 may perform matrix processing using a variety of operand precisions including single precision floating-point (e.g., 32 bits), half-precision floating point (e.g., 16 bits), integer words (16 bits), bytes (8 bits), and half-bytes (4 bits). For example, a neural network implementation extracts features of each rendered scene, potentially combining details from multiple frames, to construct a high-quality final image.

In deep learning implementations, parallel matrix multiplication work may be scheduled for execution on the tensor cores 1771. The training of neural networks, in particular, requires a significant number of matrix dot product operations. In order to process an inner-product formulation of an N×N×N matrix multiply, the tensor cores 1771 may include at least N dot-product processing elements. Before the matrix multiply begins, one entire matrix is loaded into tile registers and at least one column of a second matrix is loaded each cycle for N cycles. Each cycle, there are N dot products that are processed.

Matrix elements may be stored at different precisions depending on the particular implementation, including 16-bit words, 8-bit bytes (e.g., INT8) and 4-bit half-bytes (e.g., INT4). Different precision modes may be specified for the tensor cores 1771 to ensure that the most efficient precision is used for different workloads (e.g., such as inferencing workloads which can tolerate quantization to bytes and half-bytes). Supported formats additionally include 64-bit floating point (FP64) and non-IEEE floating point formats such as the bfloat16 format (e.g., Brain floating point), a 16-bit floating point format with one sign bit, eight exponent bits, and eight significand bits, of which seven are explicitly stored. One example includes support for a reduced precision tensor-float (TF32) mode, which performs computations using the range of FP32 (8-bits) and the precision of FP16 (10-bits). Reduced precision TF32 operations can be performed on FP32 inputs and produce FP32 outputs at higher performance relative to FP32 and increased precision relative to FP16. In some examples, one or more 8-bit floating point formats (FP8) are supported.

In some examples the tensor cores 1771 support a sparse mode of operation for matrices in which the vast majority of values are zero. The tensor cores 1771 include support for sparse input matrices that are encoded in a sparse matrix representation (e.g., coordinate list encoding (COO), compressed sparse row (CSR), compress sparse column (CSC), etc.). The tensor cores 1771 also include support for compressed sparse matrix representations in the event that the sparse matrix representation may be further compressed. Compressed, encoded, and/or compressed and encoded matrix data, along with associated compression and/or encoding metadata, can be read by the tensor cores 1771 and the non-zero values can be extracted. For example, for a given input matrix A, a non-zero value can be loaded from the compressed and/or encoded representation of at least a portion of matrix A. Based on the location in matrix A for the non-zero value, which may be determined from index or coordinate metadata associated with the non-zero value, a corresponding value in input matrix B may be loaded. Depending on the operation to be performed (e.g., multiply), the load of the value from input matrix B may be bypassed if the corresponding value is a zero value. In some examples, the pairings of values for certain operations, such as multiply operations, may be pre-scanned by scheduler logic and only operations between non-zero inputs are scheduled. Depending on the dimensions of matrix A and matrix B and the operation to be performed, output matrix C may be dense or sparse. Where output matrix C is sparse and depending on the configuration of the tensor cores 1771, output matrix C may be output in a compressed format, a sparse encoding, or a compressed sparse encoding.

The ray tracing cores 1772 may accelerate ray tracing operations for both real-time ray tracing and non-real-time ray tracing implementations. In particular, the ray tracing cores 1772 may include ray traversal/intersection circuitry for performing ray traversal using bounding volume hierarchies (BVHs) and identifying intersections between rays and primitives enclosed within the BVH volumes. The ray tracing cores 1772 may also include circuitry for performing depth testing and culling (e.g., using a Z buffer or similar arrangement). In one implementation, the ray tracing cores 1772 perform traversal and intersection operations in concert with the image denoising techniques described herein, at least a portion of which may be executed on the tensor cores 1771. For example, the tensor cores 1771 may implement a deep learning neural network to perform denoising of frames generated by the ray tracing cores 1772. However, the CPU(s) 1761, graphics cores 1770, and/or ray tracing cores 1772 may also implement all or a portion of the denoising and/or deep learning algorithms.

In addition, as described above, a distributed approach to denoising may be employed in which the GPU 1780 is in a computing device coupled to other computing devices over a network or high-speed interconnect. In this distributed approach, the interconnected computing devices may share neural network learning/training data to improve the speed with which the overall system learns to perform denoising for different types of image frames and/or different graphics applications.

The ray tracing cores 1772 may process all BVH traversal and/or ray-primitive intersections, saving the graphics cores 1770 from being overloaded with thousands of instructions per ray. For example, each ray tracing core 1772 includes a first set of specialized circuitry for performing bounding box tests (e.g., for traversal operations) and/or a second set of specialized circuitry for performing the ray-triangle intersection tests (e.g., intersecting rays which have been traversed). Thus, for example, the multi-core group 1765A can simply launch a ray probe, and the ray tracing cores 1772 independently perform ray traversal and intersection and return hit data (e.g., a hit, no hit, multiple hits, etc.) to the thread context. The other cores 1770, 1771 are freed to perform other graphics or compute work while the ray tracing cores 1772 perform the traversal and intersection operations.

Optionally, each ray tracing core 1772 may include a traversal unit to perform BVH testing operations and/or an intersection unit which performs ray-primitive intersection tests. The intersection unit generates a “hit”, “no hit”, or “multiple hit” response, which it provides to the appropriate thread. During the traversal and intersection operations, the execution resources of the other cores (e.g., graphics cores 1770 and tensor cores 1771) are freed to perform other forms of graphics work.

In some examples described below, a hybrid rasterization/ray tracing approach is used in which work is distributed between the graphics cores 1770 and ray tracing cores 1772.

The ray tracing cores 1772 (and/or other cores 1770, 1771) may include hardware support for a ray tracing instruction set such as Microsoft's DirectX Ray Tracing (DXR) which includes a DispatchRays command, as well as ray-generation, closest-hit, any-hit, and miss shaders, which enable the assignment of unique sets of shaders and textures for each object. Another ray tracing platform which may be supported by the ray tracing cores 1772, graphics cores 1770 and tensor cores 1771 is Vulkan API (e.g., Vulkan version 1.1.85 and later). Note, however, that the underlying principles described herein are not limited to any particular ray tracing ISA.

In general, the various cores 1772, 1771, 1770 may support a ray tracing instruction set that includes instructions/functions for one or more of ray generation, closest hit, any hit, ray-primitive intersection, per-primitive and hierarchical bounding box construction, miss, visit, and exceptions. More specifically, some examples include ray tracing instructions to perform one or more of the following functions:
Ray Generation—Ray generation instructions may be executed for each pixel, sample, or other user-defined work assignment.
Closest Hit—A closest hit instruction may be executed to locate the closest intersection point of a ray with primitives within a scene.
Any Hit—An any hit instruction identifies multiple intersections between a ray and primitives within a scene, potentially to identify a new closest intersection point.
Intersection—An intersection instruction performs a ray-primitive intersection test and outputs a result.
Per-primitive Bounding box Construction—This instruction builds a bounding box around a given primitive or group of primitives (e.g., when building a new BVH or other acceleration data structure).
Miss—Indicates that a ray misses all geometry within a scene, or specified region of a scene.
Visit—Indicates the child volumes a ray will traverse.
Exceptions—Includes various types of exception handlers (e.g., invoked for various error conditions).

In some examples the ray tracing cores 1772 may be adapted to accelerate general-purpose compute operations that can be accelerated using computational techniques that are analogous to ray intersection tests. A compute framework can be provided that enables shader programs to be compiled into low level instructions and/or primitives that perform general-purpose compute operations via the ray tracing cores. Exemplary computational problems that can benefit from compute operations performed on the ray tracing cores 1772 include computations involving beam, wave, ray, or particle propagation within a coordinate space. Interactions associated with that propagation can be computed relative to a geometry or mesh within the coordinate space. For example, computations associated with electromagnetic signal propagation through an environment can be accelerated via the use of instructions or primitives that are executed via the ray tracing cores. Diffraction and reflection of the signals by objects in the environment can be computed as direct ray-tracing analogies.

Ray tracing cores 1772 can also be used to perform computations that are not directly analogous to ray tracing. For example, mesh projection, mesh refinement, and volume sampling computations can be accelerated using the ray tracing cores 1772. Generic coordinate space calculations, such as nearest neighbor calculations can also be performed. For example, the set of points near a given point can be discovered by defining a bounding box in the coordinate space around the point. BVH and ray probe logic within the ray tracing cores 1772 can then be used to determine the set of point intersections within the bounding box. The intersections constitute the origin point and the nearest neighbors to that origin point. Computations that are performed using the ray tracing cores 1772 can be performed in parallel with computations performed on the graphics cores 1772 and tensor cores 1771. A shader compiler can be configured to compile a compute shader or other general-purpose graphics processing program into low level primitives that can be parallelized across the graphics cores 1770, tensor cores 1771, and ray tracing cores 1772.

Building larger and larger silicon dies is challenging for a variety of reasons. As silicon dies become larger, manufacturing yields become smaller and process technology requirements for different components may diverge. On the other hand, in order to have a high-performance system, key components should be interconnected by high speed, high bandwidth, low latency interfaces. These contradicting needs pose a challenge to high performance chip development.

Embodiments described herein provide techniques to disaggregate an architecture of a system on a chip integrated circuit into multiple distinct chiplets that can be packaged onto a common chassis. In some examples, a graphics processing unit or parallel processor is composed from diverse silicon chiplets that are separately manufactured. A chiplet is an at least partially packaged integrated circuit that includes distinct units of logic that can be assembled with other chiplets into a larger package. A diverse set of chiplets with different IP core logic can be assembled into a single device. Additionally the chiplets can be integrated into a base die or base chiplet using active interposer technology. The concepts described herein enable the interconnection and communication between the different forms of IP within the GPU. The development of IPs on different process may be mixed. This avoids the complexity of converging multiple IPs, especially on a large SoC with several flavors IPs, to the same process.

Enabling the use of multiple process technologies improves the time to market and provides a cost-effective way to create multiple product SKUs. For customers, this means getting products that are more tailored to their requirements in a cost effective and timely manner. Additionally, the disaggregated IPs are more amenable to being power gated independently, components that are not in use on a given workload can be powered off, reducing overall power consumption.

References to “some examples,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

Examples include, but are not limited to:
1. A non-transitory machine readable medium having stored thereon instructions which, when executed by a processor is to cause the processor to perform a method, the method comprising:
   performing a forward pass on a layer of a plurality of the layers of a machine learning (ML) model in a first memory to generate at least one tensor;
   extracting context data associated with layer of a plurality of layers of the ML model;
   determining, based at least in part on the context data and the at least one tensor, the at least one tensor is to be evicted from the first memory to a second memory, wherein the second memory is slower than the first memory;
   evicting the at least one tensor to the second memory from the first memory in response to the determining the at least one tensor is to be evicted;
   determining, based at least in part on the context data collected from performing the forward pass, the at least one tensor is to be prefetched from the second memory prior to performing a backward pass on the layer;
   prefetching the evicted tensor from the second memory in response to the determining of prefetching the evicted tensor; and
   performing the backward pass on the layer in the first memory to update at least one parameter of the layer.
2. The non-transitory machine readable medium of example 1, further comprising:
   receiving a request to train a machine learning model, wherein the request includes at least one of an identifier of a machine learning model to train, an identifier of a machine learning algorithm to train, an identifier of a machine learning model to fine-tune, an indication of a location for training data, an indication of a location for validation and/or testing data, an indication of where to store artifacts generated by the training of the machine learning model, an indication of a compute instance to use for training, and a training program.
3. The non-transitory machine readable medium of any of examples 1-2, wherein the forward pass memory is one of dynamic random access memory or high-bandwidth memory.
4. The non-transitory machine readable medium of any of examples 1-3, wherein the slower memory is one of a solid state disk or a magnetic disk.
5. The non-transitory machine readable medium of any of examples 1-4, wherein the machine learning model is a deep neural network model.
6. The non-transitory machine readable medium of any of examples 1-5, wherein the determining the tensor is to be evicted to the second memory is based on context data comprising one or more of a size of the tensor, memory bandwidth utilization, a current active layer, an estimated time of reuse, an effective transfer rate, an effective prefetch rate, and current evictions.
7. The non-transitory machine readable medium of any of examples 1-6, further comprising:
   registering one or more hooks with a software framework, wherein at least one of the one or more hooks is to collect information on a tensor including a size of the tensor and an address of the tensor.
8. An apparatus comprising:
   a processor core to execute a machine learning training routine;
   a memory of a first type coupled to the processor core; and
   a memory of a second type coupled to the processor core, wherein the memory of the second type is slower than the memory of the first type, wherein the training routine comprises to:
      perform a forward pass on a layer of a plurality of layers of a machine learning (ML) model in the memory of the first type to generate at least one tensor;
      extract context data associated with the layer of the plurality of layers of the ML model;
      determine, based at least in part on the context data and the at least one tensor, the at least one tensor is to be evicted from the memory of the first type to a memory of the second type, wherein the memory of memory of the second type is slower than the memory of the first type;
      evict the at least one tensor to the second memory from the first memory in response to the determining the at least one tensor is to be evicted;
      determine, based at least in part on the context data collected from performing the forward pass, the at least one tensor is to be prefetched from the memory of the second type prior to performing a backward pass on the layer;
      prefetch the evicted tensor from the memory of the second type in response to the determining of prefetching the evicted tensor; and
      perform the backward pass on the layer in the memory of the first type to update at least one parameter of the layer.
9. The apparatus of example 8, wherein the processor core is a core of an accelerator.
10. The apparatus of any of examples 8-9, wherein the memory of the first type is one of dynamic random access memory or high-bandwidth memory.
11. The apparatus of any of examples 8-10, wherein the memory of second type is one of a solid state disk or a magnetic disk.
12. The apparatus of any of examples 8-11, wherein the machine learning model is a deep neural network model.
13. The apparatus of any of examples 8-12, wherein the processor core is a core of a central processing unit.
14. The apparatus of any of examples 8-13, wherein to determine the tensor is to be evicted to the memory of the second type is based on context data comprising one or more of a size of the tensor, memory bandwidth utilization, a current active layer, an estimated time of reuse, an effective transfer rate, an effective prefetch rate, and current evictions.
15. The apparatus of any of example 14, wherein the training routine is further to register one or more hooks with a software framework, wherein at least one of the one or more hooks is to collect information on a tensor including a size of the tensor and an address of the tensor.
16. A system comprising:
   a first plurality of compute devices to support a model hosting service of a cloud provider network;
   a second plurality of compute devices to support a machine learning model training service of the cloud provider network, wherein the machine learning (ML) model training service of the cloud provider network is to train a ML model, to be hosted by the model hosting service, by:
      performing a forward pass on a layer of a plurality of the layers of the ML model in memory of a first type to generate at least one tensor;
      extracting context data associated with layer of a plurality of layers of the ML model;
      determining, based at least in part on the context data and the at least one tensor, the at least one tensor is to be evicted from the memory of the first type to a memory of a second type, wherein the memory of memory of the second type is slower than the memory of the first type;
      evicting the at least one tensor to the second memory from the first memory in response to the determining the at least one tensor is to be evicted;
      determining, based at least in part on the context data collected from performing the forward pass, the at least one tensor is to be prefetched from the memory of the second type prior to performing a backward pass on the layer;
      prefetching the evicted tensor from the memory of the second type in response to the determining of prefetching the evicted tensor; and
      performing the backward pass on the layer in the memory of the first type to update at least one parameter of the layer.
17. The system of example 16, wherein the forward pass memory is one of dynamic random access memory or high-bandwidth memory.
18. The system of any of examples 16-17, wherein the slower memory is one of a solid state disk or a magnetic disk.
19. The system of examples 16-18, wherein the machine learning model training service is further to register one or more hooks with a software framework, wherein at least one of the one or more hooks is to collect information on a tensor including a size of the tensor and an address of the tensor.
20. The system of examples 16-19, wherein the determining tensor is to be evicted to the memory of the second type is based on context data comprising one or more of a size of the tensor, memory bandwidth utilization, a current active layer, an estimated time of reuse, an effective transfer rate, an effective prefetch rate, and current evictions.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. A non-transitory machine readable medium having stored thereon instructions which, when executed by a processor is to cause the processor to perform a method, the method comprising:
performing a forward pass on a layer of a plurality of the layers of a machine learning (ML) model in a first memory to generate at least one tensor;
extracting context data associated with layer of a plurality of layers of the ML model;
determining, based at least in part on the context data and the at least one tensor, the at least one tensor is to be evicted from the first memory to a second memory, wherein the second memory is slower than the first memory;
evicting the at least one tensor to the second memory from the first memory in response to the determining the at least one tensor is to be evicted;
determining, based at least in part on the context data collected from performing the forward pass, the at least one tensor is to be prefetched from the second memory prior to performing a backward pass on the layer;
prefetching the evicted tensor from the second memory in response to the determining of prefetching the evicted tensor; and
performing the backward pass on the layer in the first memory to update at least one parameter of the layer.

2. The non-transitory machine readable medium of claim 1, further comprising:
receiving a request to train a machine learning model, wherein the request includes at least one of an identifier of a machine learning model to train, an identifier of a machine learning algorithm to train, an identifier of a machine learning model to fine-tune, an indication of a location for training data, an indication of a location for validation and/or testing data, an indication of where to store artifacts generated by the training of the machine learning model, an indication of a compute instance to use for training, and a training program.

3. The non-transitory machine readable medium of claim 1, wherein the forward pass memory is one of dynamic random access memory or high-bandwidth memory.

4. The non-transitory machine readable medium of claim 1, wherein the slower memory is one of a solid state disk or a magnetic disk.

5. The non-transitory machine readable medium of claim 1, wherein the machine learning model is a deep neural network model.

6. The non-transitory machine readable medium of claim 1, wherein the determining the tensor is to be evicted to the second memory is based on context data comprising one or more of a size of the tensor, memory bandwidth utilization, a current active layer, an estimated time of reuse, an effective transfer rate, an effective prefetch rate, and current evictions.

7. The non-transitory machine readable medium of claim 1, further comprising:
registering one or more hooks with a software framework, wherein at least one of the one or more hooks is to collect information on a tensor including a size of the tensor and an address of the tensor.

8. An apparatus comprising:
a processor core to execute a machine learning training routine;
a memory of a first type coupled to the processor core; and
a memory of a second type coupled to the processor core, wherein the memory of the second type is slower than the memory of the first type, wherein the training routine comprises to:
perform a forward pass on a layer of a plurality of layers of a machine learning (ML) model in the memory of the first type to generate at least one tensor;
extract context data associated with the layer of the plurality of layers of the ML model;
determine, based at least in part on the context data and the at least one tensor, the at least one tensor is to be evicted from the memory of the first type to a memory of the second type, wherein the memory of memory of the second type is slower than the memory of the first type;
evict the at least one tensor to the second memory from the first memory in response to the determining the at least one tensor is to be evicted;
determine, based at least in part on the context data collected from performing the forward pass, the at least one tensor is to be prefetched from the memory of the second type prior to performing a backward pass on the layer;
prefetch the evicted tensor from the memory of the second type in response to the determining of prefetching the evicted tensor; and
perform the backward pass on the layer in the memory of the first type to update at least one parameter of the layer.

9. The apparatus of claim 8, wherein the processor core is a core of an accelerator.

10. The apparatus of claim 8, wherein the memory of the first type is one of dynamic random access memory or high-bandwidth memory.

11. The apparatus of claim 8, wherein the memory of second type is one of a solid state disk or a magnetic disk.

12. The apparatus of claim 8, wherein the machine learning model is a deep neural network model.

13. The apparatus of claim 8, wherein the processor core is a core of a central processing unit.

14. The apparatus of claim 8, wherein to determine the tensor is to be evicted to the memory of the second type is based on context data comprising one or more of a size of the tensor, memory bandwidth utilization, a current active layer, an estimated time of reuse, an effective transfer rate, an effective prefetch rate, and current evictions.

15. The apparatus of claim 14, wherein the training routine is further to register one or more hooks with a software framework, wherein at least one of the one or more hooks is to collect information on a tensor including a size of the tensor and an address of the tensor.

16. A system comprising:
a first plurality of compute devices to support a model hosting service of a cloud provider network;
a second plurality of compute devices to support a machine learning model training service of the cloud provider network, wherein the machine learning (ML) model training service of the cloud provider network is to train a ML model, to be hosted by the model hosting service, by:
performing a forward pass on a layer of plurality of layers of the ML model in memory of a first type to generate at least one tensor;
extracting context data associated with layer of a plurality of layers of the ML model;
determining, based at least in part on the context data and the at least one tensor, the at least one tensor is to be evicted from the memory of the first type to a memory of a second type, wherein the memory of memory of the second type is slower than the memory of the first type;
evicting the at least one tensor to the second memory from the first memory in response to the determining the at least one tensor is to be evicted;
determining, based at least in part on the context data collected from performing the forward pass, the at least one tensor is to be prefetched from the memory of the second type prior to performing a backward pass on the layer;
prefetching the evicted tensor from the memory of the second type in response to the determining of prefetching the evicted tensor; and
performing the backward pass on the layer in the memory of the first type to update at least one parameter of the layer.

17. The system of claim 16, wherein the forward pass memory is one of dynamic random access memory or high-bandwidth memory.

18. The system of claim 16, wherein the slower memory is one of a solid state disk or a magnetic disk.

19. The system of claim 16, wherein the machine learning model training service is further to register one or more hooks with a software framework, wherein at least one of the one or more hooks is to collect information on a tensor including a size of the tensor and an address of the tensor.

20. The system of claim 16, wherein the determining tensor is to be evicted to the memory of the second type is based on context data comprising one or more of a size of the tensor, memory bandwidth utilization, a current active layer, an estimated time of reuse, an effective transfer rate, an effective prefetch rate, and current evictions.
